(19) United States
(12) Patent Application Publication
(10) Pub. No.: US 2024/0107587 A1
(43) Pub. Date: Mar. 28, 2024

(54) WIRELESS DEVICE, INTERMEDIATE DEVICE, AND METHOD

(71) Applicant: NEC Corporation, Tokyo (JP)

(72) Inventor: Shingo KIKUCHI, Tokyo (JP)

(73) Assignee: NEC Corporation, Tokyo (JP)

(21) Appl. No.: 18/371,226

(22) Filed: Sep. 21, 2023

(30) Foreign Application Priority Data
Sep. 26, 2022 (JP) 2022-152322

(51) Int. Cl. H04W 74/08

(52) U.S. Cl. CPC H04W 74/0833; H04W 88/085

(57) ABSTRACT

In order to appropriately transmit a signal, based on presence or absence of a user device, a wireless device according to the present disclosure communicates with an intermediate device that duplicates or synthesizes and transmits a signal between a radio access network node communicating with the user device via the wireless device, and a plurality of the wireless devices, detects a PRACH signal transmitted from the user device, and performs transmission of a U-Plane signal to the radio access network node via the intermediate device, based on a detection result of the PRACH signal by a detection unit.

This application is based upon and claims the benefit of priority from Japanese Patent Application No. 2022-152322, filed on Sep. 26, 2022, the disclosure of which is incorporated herein in its entirety by reference.

### TECHNICAL FIELD

The present disclosure relates to a wireless device, an intermediate device, and a method.

### BACKGROUND ART

There is known a configuration in which, when a radio access network node communicates with user equipment (UE) via a plurality of wireless devices, a fronthaul multiplexer (FHM) is arranged between the radio access network node and the wireless device. Regarding a signal on a fronthaul, in a downlink, the FHM copies a signal from the radio access network node, and transmits the signal to a plurality of child stations. Meanwhile, in an uplink, the FHM synthesizes signals from a plurality of child stations, and transmits the synthesized signals to the radio access network node. NPL 1 (NTT DOCOMO Technical Journal vol. 24, No. 2, “Development of base station device toward introduction of 3.5 GHz band TD-LTE”) describes that a plurality of wireless devices can be accommodated as one cell by arranging the FHM between the radio access network node and a plurality of wireless devices.

As described in NPL 2 (ORAN-WG4.CUS.0-v01.00, Technical Specification, “0-RAN Fronthaul Working Group Control, User and Synchronization Plane Specification”), in open radio access network (O-RAN) alliance, an O-RAN fronthaul specification is defined as an interface between a radio access network node (O-DU:O-RAN distributed unit) and a wireless device (O-RU; O-RAN radio unit). In the O-RAN fronthaul specification, a function split of a fronthaul for an O-RAN user data plane (U-Plane) and an O-RAN control plane (C-Plane) is defined.

### SUMMARY

In an O-RAN fronthaul specification described above, when an O-DU communicates with UE via a plurality of O-RUs, it is possible to arrange an FHM between the O-DU and the plurality of O-RUs. In this case, uplink signals transmitted from the plurality of O-RUs are synthesized by the FHM, and demodulated by the O-DU. However, when there is a cell in which no UE is present in an area covered by a plurality of O-RUs, interference from another cell, device noise, and the like are synthesized by the FHM. As a result, there has been a problem that, in comparison with a case where only a signal from a cell in which UE is present is demodulated, demodulation performance of the O-DU deteriorates.

This is because an uplink signal is transmitted to the O-DU from a plurality of O-RUs regardless of presence or absence of UE.

In view of the problem described above, an object of the present disclosure is to provide a wireless device, a method for a wireless device, and a program that enable appropriately transmitting a signal, based on presence or absence of a user device.

A wireless device according to one aspect of the present disclosure includes: a communication unit that communicates with an intermediate device duplicating or synthesizing and transmitting a signal between a radio access network node communicating with a user device via the wireless device, and a plurality of the wireless devices; and a detection unit that detects a PRACH signal transmitted from the user device, wherein the communication unit performs transmission of a U-Plane signal to the radio access network node via the intermediate device, based on a detection result of the PRACH signal by the detection unit.

An intermediate device according to one aspect of the present disclosure is an intermediate device that duplicates or synthesizes and transmits a signal between a plurality of wireless devices communicating with a user device, and a radio access network node communicating with the user device via the wireless device, the intermediate device including a communication unit that communicates with the wireless device and the radio access network node, wherein the communication unit receives, from the wireless device, a detection result of a PRACH signal transmitted from the user device, and the communication unit transmits, to the radio access network node, a U-Plane signal received from the wireless device, based on the detection result.

A method according to one aspect of the present disclosure includes: communicating with an intermediate device that duplicates or synthesizes and transmits a signal between a radio access network node communicating with a user device via a wireless device, and a plurality of the wireless devices; detecting a PRACH signal transmitted from the user device; and performing transmission of a U-Plane signal to the radio access network node via the intermediate device, based on a detection result of the PRACH signal.

A program according to one aspect of the present disclosure executes: communicating with an intermediate device that duplicates or synthesizes and transmits a signal between a radio access network node communicating with a user device via a wireless device, and a plurality of the wireless devices; detecting a PRACH signal transmitted from the user device; and performing transmission of a U-Plane signal to the radio access network node via the intermediate device, based on a detection result of the PRACH signal.

According to the present disclosure, a wireless device, an intermediate device, a method, and a program that enable appropriately transmitting a signal, based on presence or absence of a user device can be provided.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of a wireless device according to a first example embodiment;

FIG. 2 is a block diagram illustrating a configuration of a wireless communication system 100 according to the first example embodiment;

FIG. 3 is a flowchart illustrating an operation of the wireless device according to the first example embodiment;

FIG. 4 is a block diagram illustrating a configuration example of a wireless device according to a second example embodiment;

FIG. 5 is a block diagram illustrating a configuration of a wireless device according to a third example embodiment;

FIG. 6 is a block diagram illustrating a configuration of a wireless communication system according to the third example embodiment;

FIG. 7 is a flowchart illustrating an operation of the wireless device according to the third example embodiment;

FIG. 8 is a block diagram illustrating a configuration of a wireless device according to a fourth example embodiment;

FIG. 9 is a block diagram illustrating a configuration of a wireless communication system according to the fourth example embodiment;

FIG. 10 is a block diagram illustrating a configuration example of a wireless device according to the fourth example embodiment;

FIG. 11 is a flowchart illustrating an operation of a wireless device according to the fourth example embodiment;

FIG. 12 is a block diagram illustrating a configuration of an intermediate device according to a fifth example embodiment;

FIG. 13 is a block diagram illustrating a configuration of a wireless communication system according to the fifth example embodiment;

FIG. 14 is a flowchart illustrating an operation of an intermediate device according to the fifth example embodiment;

FIG. 15 is a block diagram illustrating an example of the intermediate device according to the fifth example embodiment;

FIG. 16 is a block diagram illustrating an example of the intermediate device according to the fifth example embodiment;

FIG. 17 is a block diagram illustrating an example of the intermediate device according to the fifth example embodiment;

FIG. 18 is a block diagram illustrating a configuration of an intermediate device according to a sixth example embodiment;

FIG. 19 is a block diagram illustrating a configuration of a wireless communication system according to the sixth example embodiment;

FIG. 20 is a flowchart illustrating an operation of the intermediate device according to the sixth example embodiment;

FIG. 21 is a block diagram illustrating a configuration of an intermediate device according to a seventh example embodiment;

FIG. 22 is a block diagram illustrating a configuration of a wireless communication system according to the seventh example embodiment;

FIG. 23 is a flowchart illustrating an operation of the intermediate device according to the seventh example embodiment;

FIG. 24 is a block diagram illustrating a configuration of an intermediate device according to an eighth example embodiment;

FIG. 25 is a block diagram illustrating a configuration of a wireless communication system according to the eighth example embodiment;

FIG. 26 is a flowchart illustrating an operation of an intermediate device according to the eighth example embodiment;

FIG. 27 is a block diagram illustrating a configuration of an intermediate device according to a ninth example embodiment;

FIG. 28 is a block diagram illustrating a configuration of a wireless communication system according to the ninth example embodiment; and

FIG. 29 is a flowchart illustrating an operation of the intermediate device according to the ninth example embodiment.

### EXAMPLE EMBODIMENT

Next, example embodiments of the present disclosure are described in detail with reference to the drawings. Note that, a similar reference sign is assigned to a component having a similar function, in each example embodiment described in each of the drawings and the specification.

### First Example Embodiment

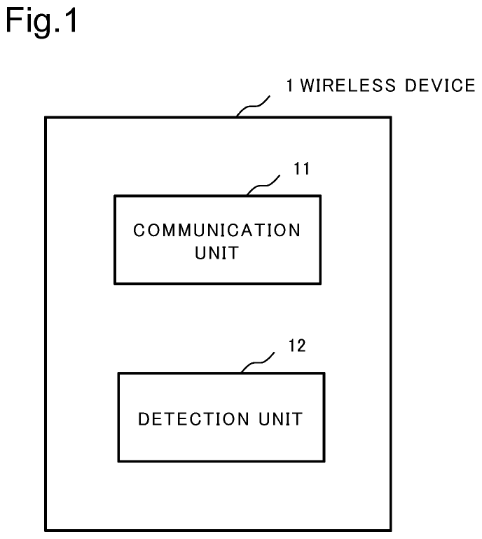

FIG. 1 is a block diagram illustrating a configuration of a wireless device 1 according to a first example embodiment of the present disclosure.

Referring to FIG. 1, the wireless device 1 according to the first example embodiment of the present disclosure includes a communication unit 11 and a detection unit 12.

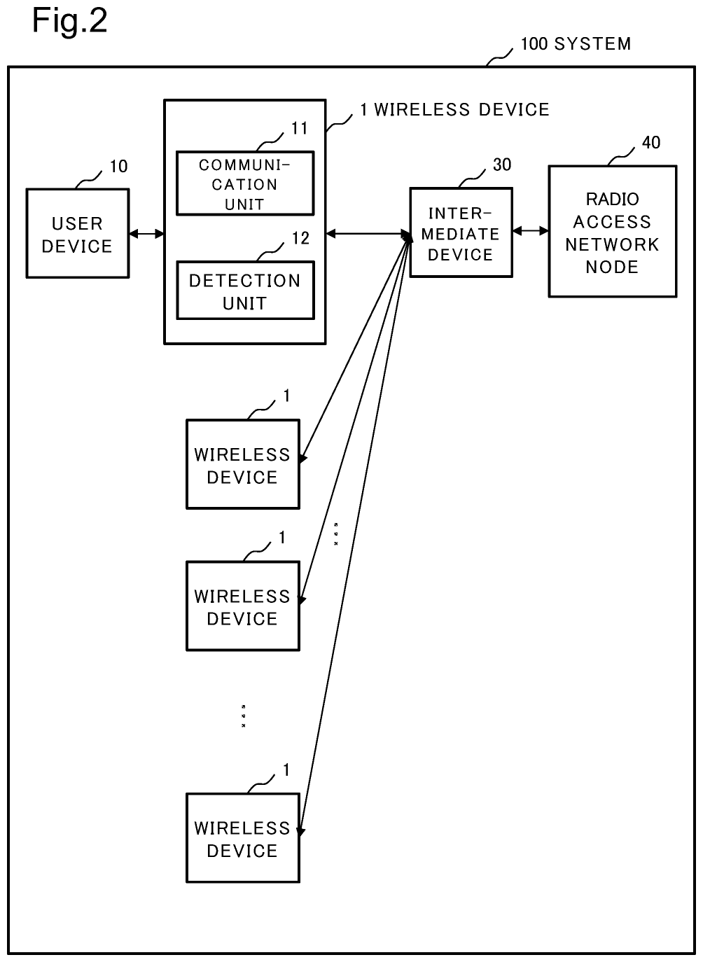

FIG. 2 is a block diagram illustrating a configuration of a wireless communication system 100 according to the first example embodiment of the present disclosure.

Referring to FIG. 2, the wireless communication system 100 according to the first example embodiment of the present disclosure includes a plurality of the wireless devices 1, a user device 10, an intermediate device 30, and a radio access network node 40.

The wireless device 1 is a device that communicates with the user device 10, and performs processing of a wireless frequency.

The communication unit 11 of the wireless device 1 performs transmission and reception of data to and from another device. The communication unit 11 transmits data transmitted from the user device 10, to the radio access network node 40 via the intermediate device 30.

The detection unit 12 of the wireless device 1 detects a physical random access channel (PRACH) signal transmitted from the user device 10. The PRACH signal is a signal used when the user device 10 performs initial access or connection establishment with a cell by handover or the like, or performs resynchronization.

Further, the communication unit 11 transmits a U-Plane signal to the radio access network node 40, based on a detection result of the PRACH signal by the detection unit 12.

The user device 10 performs communication with the radio access network node 40 via the wireless device 1 and the intermediate device 30.

The intermediate device 30 is arranged between a plurality of the wireless devices 1 and the radio access network node 40. The intermediate device 30 duplicates or synthesizes and transmits signals from the wireless device 1 and the radio access network node 40. For example, the intermediate device 30 synthesizes uplink signals from a plurality of the wireless devices 1 (signals from the wireless device 1 to the radio access network node 40), and transmits the synthesized uplink signals to the radio access network node 40. For example, the intermediate device 30 synthesizes downlink signals from the radio access network node 40 (signals from the radio access network node 40 to the wireless device 1), and transmits the synthesized uplink signals to a plurality of the wireless devices 1.

The radio access network node 40 performs communication with the user device 10 via the wireless device 1 and the intermediate device 30.

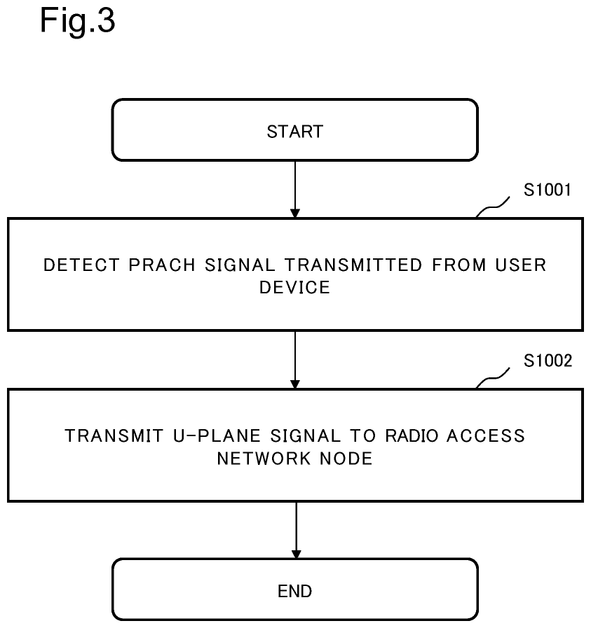

FIG. 3 is a flowchart illustrating an operation of the wireless device 1 according to the first example embodiment of the present disclosure.

In step S1001, the detection unit 12 of the wireless device 1 detects a PRACH signal transmitted from the user device 10.

In step S1002, the communication unit 11 of the wireless device 1 performs transmission of a U-Plane signal, based on a detection result of the PRACH signal by the detection unit 12. Specifically, the communication unit 11 transmits a U-Plane signal to the radio access network node 40 via the intermediate device 30.

The wireless device 1 according to the first example embodiment performs transmission of a U-Plane signal to the radio access network node 40 via the intermediate device 30, based on a detection result of a PRACH signal transmitted from the user device 10.

Therefore, the wireless device 1 according to the first example embodiment can transmit a U-Plane signal, based on a detection result of a PRACH signal. Thus, the wireless device 1 can appropriately transmit a signal, based on presence or absence of a user device. For example, it can be assumed that, when no user device connected to the wireless device 1 is present, the wireless device 1 transmits no U-Plane signal. Thereby, a problem that, in a cell in which no user device is present, interference from another cell, device noise, and the like are synthesized by an intermediate device, and demodulation performance in a radio access network node (e.g., an O-DU) deteriorates can be prevented.

### Second Example Embodiment

A wireless device 1 and a wireless communication system 100 according to a second example embodiment of the present disclosure are described.

It is assumed that the wireless device 1 according to the present example embodiment has a similar configuration to the wireless device 1 according to the first example embodiment. It is assumed that the wireless communication system 100 according to the present example embodiment has a similar configuration to the wireless communication system 100 according to the first example embodiment.

The wireless communication system 100 according to the second example embodiment of the present disclosure includes a plurality of the wireless devices 1, a user device 10, an intermediate device 30, and a radio access network node 40.

The wireless device 1 is a device that communicates with the user device 10, and performs processing of a wireless frequency. Although one user device is connected to one wireless device in FIG. 2, a plurality of user devices may be connected to one wireless device. The wireless device 1 also communicates with the intermediate device 30. The wireless device 1 communicates with the radio access network node 40 via the intermediate device 30.

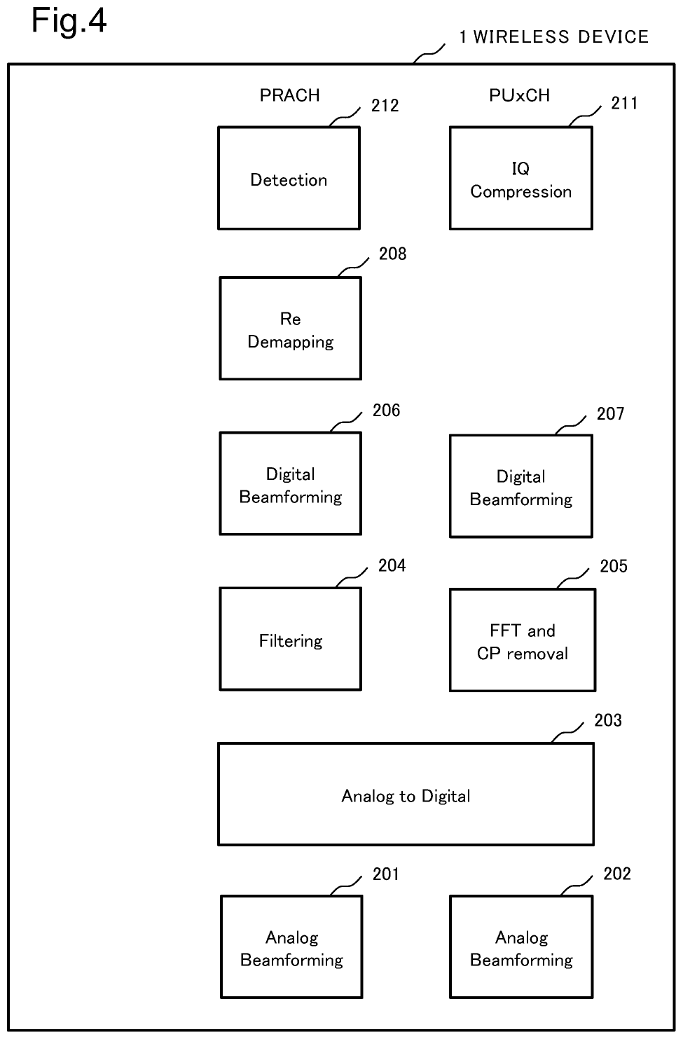

The wireless device 1 may be an O-RU described above, but is not limited thereto. When the wireless device 1 is an O-RU, the wireless device 1 may have a configuration as in, for example, FIG. 4. Referring to FIG. 4, the wireless device 1 includes, as functions of PRACH, an analog beam forming 201, an analog to digital 203, a filtering 204, a digital beam forming 206, a redemapping 208, and a detection 212. The wireless device 1 includes, as functions of PUxCH, an analog beamforming 202, an analog to digital 203, an FFT and CP removal 205, a digital beam forming 207, and an IQ compression 211. Note that, FIG. 4 is a partial modification of an O-RAN fronthaul specification described in NPL 2. The modification is that the wireless device 1 (O-RU) has a detection function included in a radio access network node (O-DU) in the O-RAN fronthaul specification described in NPL 2.

A communication unit 11 of the wireless device 1 performs data reception from another device and transmission. The communication unit 11 transmits data transmitted from the user device 10, to the radio access network node 40 via the intermediate device 30. For example, an O-RAN U-Plane signal is transmitted from the user device 10, based on an O-RAN C-Plane signal transmitted from the radio access network node 40. In this case, the communication unit 11 transmits the U-Plane signal to the radio access network node 40 via the intermediate device 30. For example, the communication unit 11 is equivalent to the IQ compression 211 in FIG. 4. Note that, a C-Plane signal is a signal including a C-Plane packet. The U-Plane signal is a signal including a U-Plane packet.

A detection unit 12 of the wireless device 1 detects that the user device 10 transmits a PRACH signal. For example, the detection unit 12 is equivalent to the detection 212 in FIG. 4.

Further, the communication unit 11 transmits a U-Plane signal to the radio access network node 40, based on a detection result of a PRACH signal by the detection unit 12. For example, it may be assumed that, when the detection unit 12 detects a PRACH signal, the communication unit 11 transmits a U-Plane signal to the radio access network node 40. In this case, when the detection unit 12 does not detect a PRACH signal, the communication unit 11 does not transmit a U-Plane signal to the radio access network node 40.

Note that, data transmitted from the user device 10 to the radio access network node 40 via the communication unit 11 are not limited to a U-Plane signal.

The user device 10 performs communication with the radio access network node 40 via the wireless device 1 and the intermediate device 30. The user device 10 may be UE described above, but is not limited thereto.

The intermediate device 30 is arranged between a plurality of the wireless devices 1 and the radio access network node 40. The intermediate device 30 duplicates or synthesizes and transmits signals from the wireless device 1 and the radio access network node 40. For example, the intermediate device 30 duplicates a downlink signal (a signal from the radio access network node 40 to the wireless device 1), and transmits the duplicated downlink signal to a plurality of the wireless devices 1. The intermediate device 30 synthesizes uplink signals from a plurality of the wireless devices 1 (signals from the wireless device 1 to the radio access network node 40), and transmits the synthesized uplink signals to the radio access network node 40. Synthesis of uplink signals is not limited to simple synthesis (e.g., calculation of a sum or an average), and may be selective synthesis (e.g., simple synthesis of a plurality of selected uplink signals, simple synthesis after weighting a plurality of uplink signals, or the like). The intermediate device 30 may be a fronthaul multiplexer (FHM) described above, but is not limited thereto.

The radio access network node 40 performs communication with the user device 10 via the wireless device 1 and the intermediate device 30. The radio access network node 40 may be an O-DU described above, but is not limited thereto.

An operation of the wireless device 1 according to the present example embodiment is an operation similar to the wireless device 1 according to the first example embodiment.

In step S1001 in FIG. 3, the detection unit 12 of the wireless device 1 detects a PRACH signal transmitted from the user device 10. The detection unit 12 may transmit a detection result of a PRACH signal to the communication unit 11. A detection result of a PRACH signal includes presence or absence of a PRACH signal, or a time of detection thereof, but is not limited thereto. For example, when the detection unit 12 detects a PRACH signal, a signal indicating detection of a PRACH signal may be output to the communication unit 11.

In step S1002, the communication unit 11 of the wireless device 1 performs transmission of a U-Plane signal, based on a detection result of the PRACH signal. Specifically, the communication unit 11 transmits a U-Plane signal to the radio access network node 40 via the intermediate device 30. The communication unit 11 may acquire a detection result of the PRACH signal from the detection unit 12 by a signal or the like, but an acquisition method is not limited thereto. A signal output by the detection unit 12 may be a signal that controls transmission of a U-Plane signal by the communication unit 11, instead of a signal indicating a detection result of a PRACH signal.

Note that, a timing at which the communication unit 11 transmits a U-Plane signal follows, for example, transmission timing information of the U-Plane signal. The transmission timing information is included in, for example, a C-Plane signal transmitted from the radio access network node 40 via the intermediate device 30.

The wireless device 1 according to the second example embodiment performs transmission of a U-Plane signal to the radio access network node 40 via the intermediate device 30, based on a detection result of a PRACH signal transmitted from the user device 10.

Thereby, an advantageous effect similar to that according to the first example embodiment is provided in the present example embodiment as well.

### Third Example Embodiment

Now, a third example embodiment of the present disclosure is described with reference to the drawings. A wireless device 2 according to the third example embodiment is different from the wireless device 1 according to the second example embodiment in that the wireless device 2 according to the third example embodiment further includes a recording unit 13.

Description is given in detail below with reference to the drawings. Note that, a similar component to that according to the second example embodiment is assigned with the same reference sign below, and description thereof is omitted.

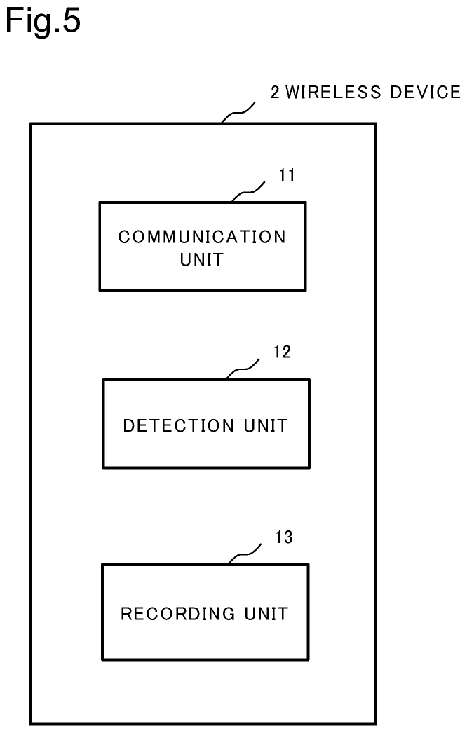

FIG. 5 is a block diagram illustrating a configuration of the wireless device 2 according to the third example embodiment of the present disclosure.

Referring to FIG. 5, the wireless device 2 according to the third example embodiment of the present disclosure includes a communication unit 11, a detection unit 12, and the recording unit 13.

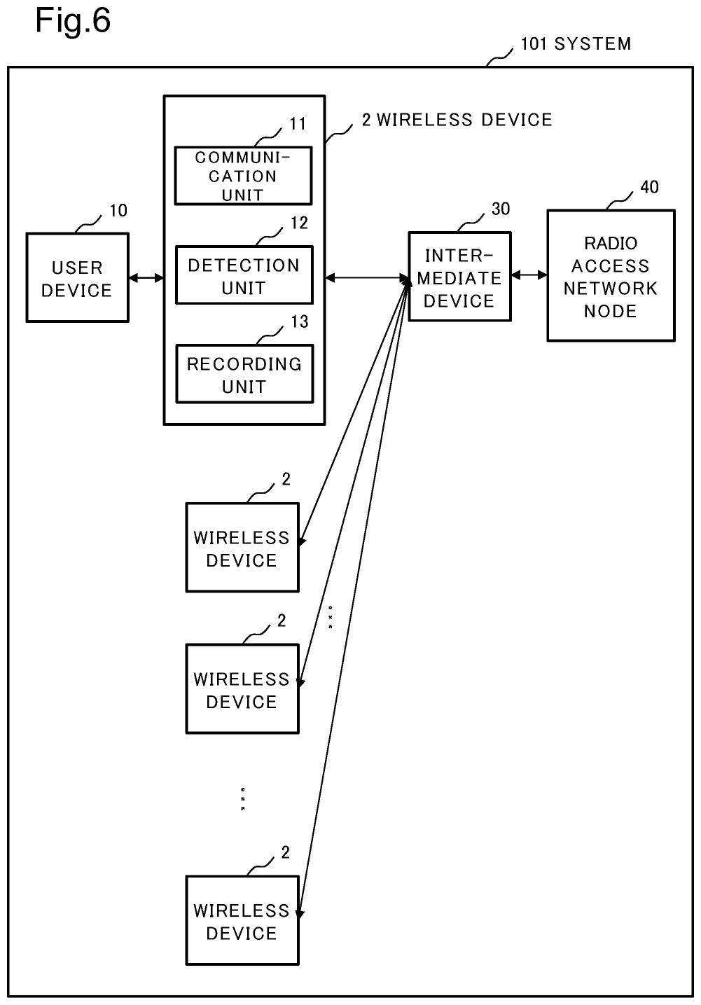

FIG. 6 is a block diagram illustrating a configuration of a wireless communication system 101 according to the third example embodiment of the present disclosure.

Referring to FIG. 6, the wireless communication system 101 according to the third example embodiment of the present disclosure includes a plurality of the wireless devices 2, a user device 10, an intermediate device 30, and a radio access network node 40.

The detection unit 12 of the wireless device 2 detects a PRACH signal transmitted from the user device 10. The detection unit 12 notifies the recording unit 13 of a detection result of a PRACH signal. Herein, it may be assumed that the detection unit 12 notifies of a detection result only when a PRACH signal is detected.

The recording unit 13 of the wireless device 2 receives a notification indicating a detection result of a PRACH signal by the detection unit 12. Thereby, the recording unit 13 acquires the detection result of the PRACH signal by the detection unit 12. Further, the recording unit 13 records the detection result of the PRACH signal by the detection unit 12. For example, the recording unit 13 may record the detection result of the PRACH signal by the detection unit 12 in a memory, but is not limited thereto. For example, only when the detection unit 12 detects a PRACH signal, the recording unit 13 may record the detection result. The recording unit 13 outputs a signal, based on a detection result of a PRACH signal by the detection unit 12. For example, the recording unit 13 may transmit, to the communication unit 11, a signal indicating that the detection unit 12 detects a PRACH signal. When receiving a detection result indicating that the detection unit 12 does not detect a PRACH signal, the recording unit 13 may output no signal. Alternatively, when not receiving a detection result indicating that the detection unit 12 detects a PRACH signal, the recording unit 13 may output no signal. The recording unit 13 may output a signal, based on a past detection result of a PRACH signal by the detection unit 12.

Next, the communication unit 11 transmits a U-Plane signal to the radio access network node 40, based on a signal output from the recording unit 13. For example, it may be assumed that, when acquiring, from the recording unit 13, a signal indicating that the detection unit 12 detects a PRACH signal, the communication unit 11 transmits a U-Plane signal to the radio access network node 40. It may be assumed that, when not acquiring the signal from the recording unit 13, the communication unit 11 transmits no U-Plane signal to the radio access network node 40. Alternatively, it may be assumed that, when acquiring, from the recording unit 13, a signal indicating that the detection unit 12 does not detect a PRACH signal, the communication unit 11 transmits no U-Plane signal to the radio access network node 40.

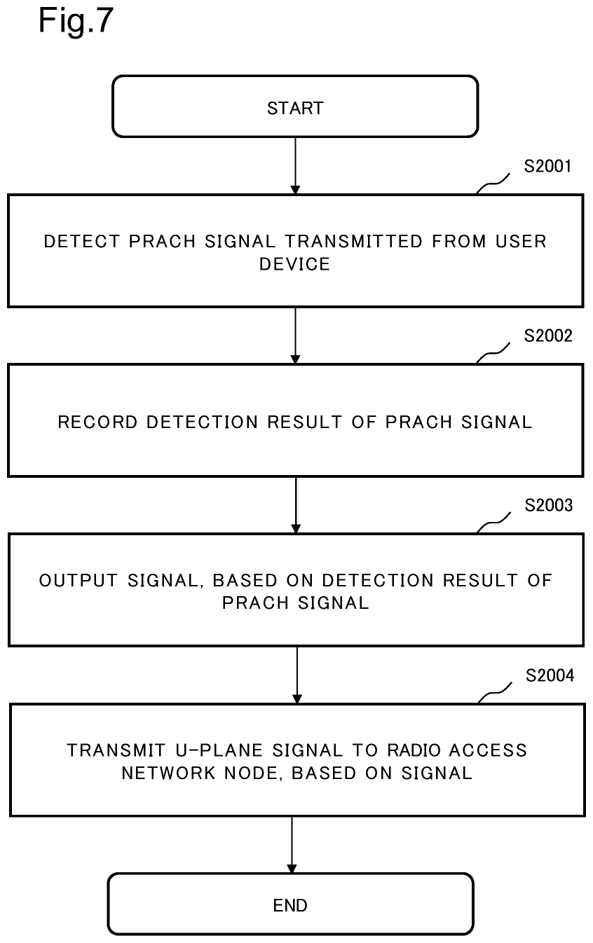

FIG. 7 is a flowchart illustrating an operation of the wireless device 2 according to the third example embodiment of the present disclosure.

In step S2001, the detection unit 12 of the wireless device 2 detects a PRACH signal transmitted from the user device 10. The detection unit 12 notifies the recording unit 13 of a detection result of a PRACH signal. A detection result of a PRACH signal includes presence or absence of a PRACH signal, or a time of detection thereof, but is not limited thereto. For example, when detecting a PRACH signal, the detection unit 12 may output, to the recording unit 13, a signal indicating that a PRACH signal is detected. Note that, the detection unit 12 may notify of the communication unit 11, of a detection result of a PRACH signal.

In step S2002, the recording unit 13 of the wireless device 2 records a detection result of a PRACH signal by the detection unit 12.

In step S2003, the recording unit 13 of the wireless device 2 outputs a signal, based on the detection result of the PRACH signal by the detection unit 12. A signal output by the recording unit 13 may include information indicating a detection result of a PRACH signal by the detection unit 12. A signal output by the recording unit 13 may be a signal that controls transmission of a U-Plane signal by the communication unit 11. Specifically, when the detection unit 12 detects a PRACH signal, the recording unit 13 may output a control signal that controls in such a way that a U-Plane signal is transmitted to the communication unit 11. It may be assumed that, when the detection unit 12 does not detect a PRACH signal, the recording unit 13 outputs no control signal that controls in such a way that a U-Plane signal is transmitted to the communication unit 11. Alternatively, when the detection unit 12 does not detect a PRACH signal, the recording unit 13 may output a control signal that controls in such a way that no U-Plane signal is transmitted to the communication unit 11.

In step S2004, the communication unit 11 of the wireless device 2 performs transmission of a U-Plane signal, based on a detection result of the PRACH signal. Specifically, the communication unit 11 transmits a U-Plane signal to the radio access network node 40 via the intermediate device 30. The communication unit 11 acquires a detection result of the PRACH signal by receiving a signal output from the recording unit 13. The communication unit 11 may acquire permission/non-permission of transmission of a U-Plane signal, by receiving a signal output from the recording unit 13. Note that, it may be assumed that the communication unit 11 acquires a detection result of the PRACH signal by receiving a signal output by the detection unit 12.

Note that, a timing at which the communication unit 11 transmits a U-Plane signal follows, for example, transmission timing information of the U-Plane signal. The transmission timing information is included in, for example, a C-Plane signal transmitted from the radio access network node 40 via the intermediate device 30. Thus, the recording unit 13 may record a detection result of a PRACH signal by the detection unit 12 and transmission timing information, and output a signal indicating the detection result of the PRACH signal to the communication unit 11 when a transmission timing indicated by the transmission timing information approaches. In this instance, it may be assumed that the recording unit 13 outputs, to the communication unit 11, a signal that controls transmission of a U-Plane signal, instead of a signal indicating a detection result of a PRACH signal.

The wireless device 2 according to the third example embodiment records a detection result of a PRACH signal transmitted from the user device 10, and performs transmission of a U-Plane signal to the radio access network node 40 via the intermediate device 30, based on a signal output based on the detection result.

Therefore, the wireless device 2 according to the third example embodiment can record a detection result of a PRACH signal, and perform transmission of a U-Plane signal, based on a signal output based on the detection result.

Thereby, an advantageous effect similar to that according to the first example embodiment is provided in the present example embodiment as well.

### Fourth Example Embodiment

Now, a fourth example embodiment of the present disclosure is described with reference to the drawings. A wireless device 3 according to the fourth example embodiment is different from the wireless device 2 according to the third example embodiment in that the wireless device 3 according to the fourth example embodiment further includes a transmission control unit 14.

Description is given in detail below with reference to the drawings. Note that, a similar component to that according to the third example embodiment is assigned with the same reference sign below, and description thereof is omitted.

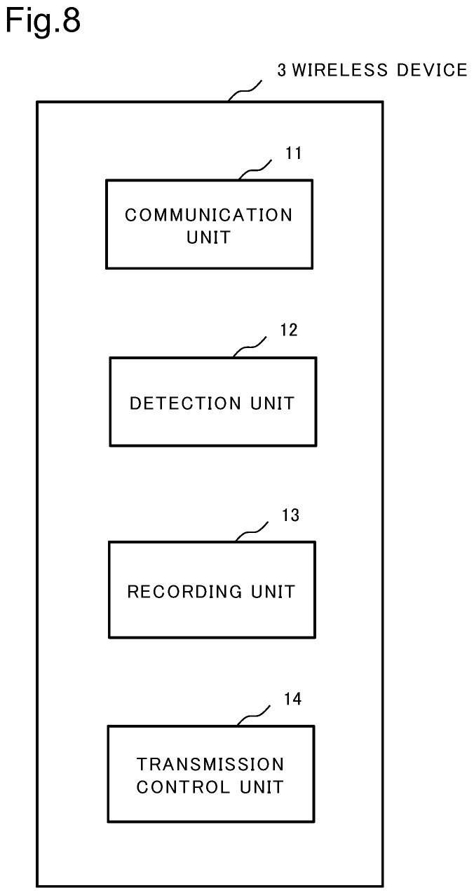

FIG. 8 is a block diagram illustrating a configuration of the wireless device 3 according to the fourth example embodiment of the present disclosure.

Referring to FIG. 8, the wireless device 3 according to the fourth example embodiment of the present disclosure includes a communication unit 11, a detection unit 12, a recording unit 13, and the transmission control unit 14.

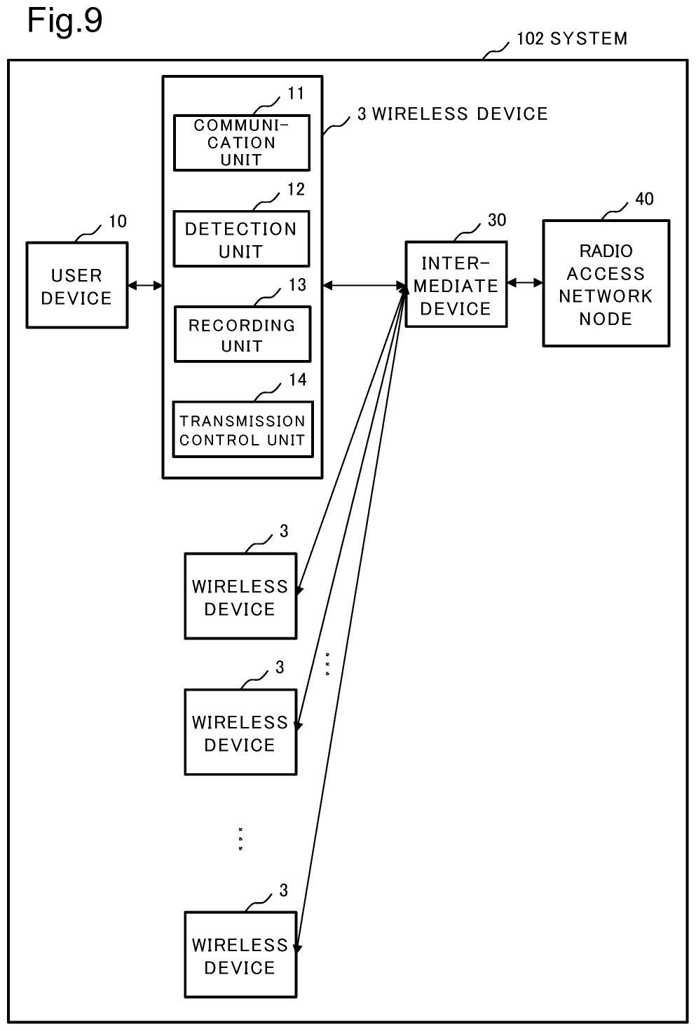

FIG. 9 is a block diagram illustrating a configuration of a wireless communication system 102 according to the fourth example embodiment of the present disclosure.

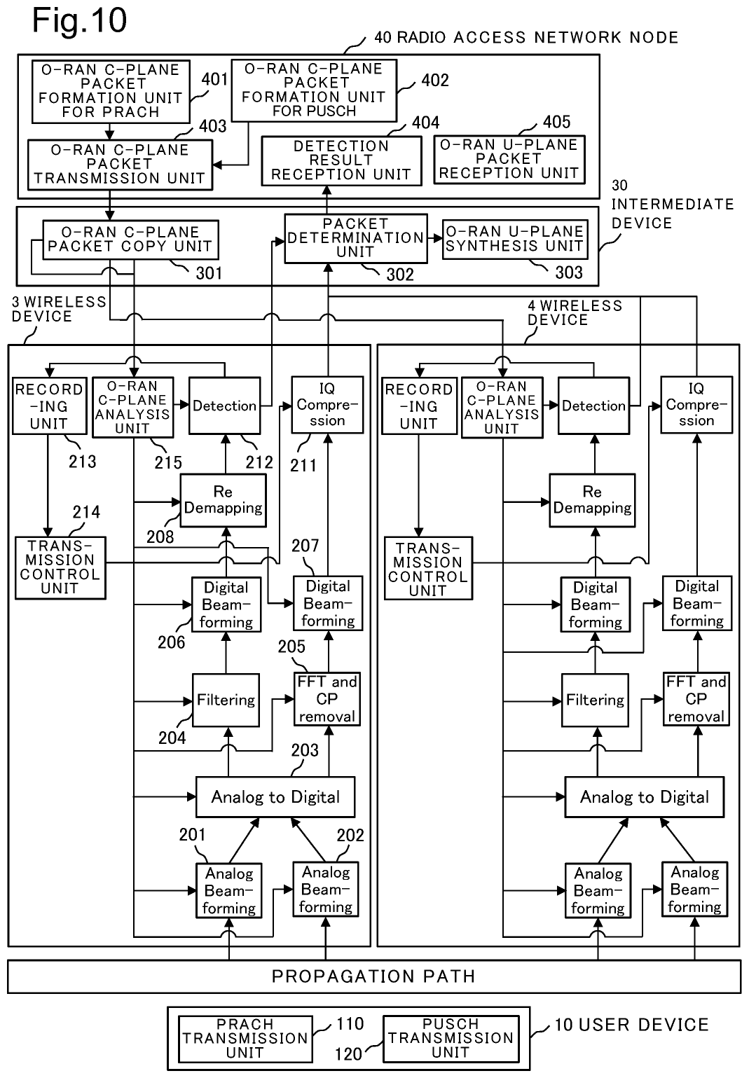

Referring to FIG. 9, the wireless communication system 102 according to the fourth example embodiment of the present disclosure includes the wireless device 3, a user device 10, an intermediate device 30, and a radio access network node 40. For example, the wireless communication system 102 may have a configuration as in FIG. 10, but is not limited thereto. Referring to FIG. 10, the wireless device 3 includes an analog beam forming 201, an analog beam forming 202, an analog to digital 203, a filtering 204, an FFT and CP removal 205, a digital beam forming 206, a digital beam forming 207, a redemapping 208, an IQ compression 211, a detection 212, a recording unit 213, a transmission control unit 214, and an O-RAN C-Plane analysis unit 215. Referring to FIG. 10, the user device 10 includes a PRACH transmission unit 110 and a PUSCH transmission unit 120. Referring to FIG. 10, the intermediate device 30 includes an O-RAN C-Plane packet copy unit 301, a packet determination unit 302, and an O-RAN U-Plane synthesis unit 303. Referring to FIG. 10, the radio access network node 40 includes an O-RAN C-Plane packet formation unit for PRACH 401, an O-RAN C-Plane packet formation unit for PUSCH 402, an O-RAN C-Plane packet transmission unit 403, a detection result reception unit 404, and an O-RAN U-Plane packet reception unit 405. A wireless device 4 has a similar configuration to the wireless device 3.

The recording unit 13 of the wireless device 3 receives a notification indicating a detection result of a PRACH signal by the detection unit 12. The recording unit 13 records the detection result of the PRACH signal by the detection unit 12. The recording unit 13 outputs a signal to the transmission control unit 14, based on a detection result of a PRACH signal by the detection unit 12. For example, the signal includes a flag as to whether the communication unit 11 performs transmission of a U-Plane signal. The signal may include information indicating a detection result of a PRACH signal by the detection unit 12. It may be assumed that the recording unit 13 outputs no signal when the detection unit 12 does not detect a PRACH signal.

The transmission control unit 14 of the wireless device 3 controls transmission of a U-Plane signal in the communication unit 11, based on a signal received from the recording unit 13. For example, when a flag indicating that the communication unit 11 transmits a U-Plane signal is on in a received signal, the transmission control unit 14 permits the communication unit 11 to transmit a U-Plane signal. On the other hand, when the flag is off, the transmission control unit 14 does not permit the communication unit 11 to transmit a U-Plane signal.

Further, the communication unit 11 transmits a U-Plane signal to the radio access network node 40, based on control by the transmission control unit 14.

It may be assumed that the transmission control unit 14 confirms whether a U-Plane signal is transmitted from the communication unit 11 to the intermediate device 30. Then, it may be assumed that, unless transmission of a U-Plane signal is performed from the communication unit 11 to the intermediate device 30 for a certain time, the transmission control unit 14 controls in such a way that the communication unit 11 transmits no U-Plane signal. In this case, it may be assumed that, until a signal is received from the recording unit 13 again, the transmission control unit 14 inhibits the communication unit 11 from transmitting a U-Plane signal. In other words, it may be assumed that, only when a signal is received from the recording unit 13 again, the transmission control unit 14 permits the communication unit 11 to transmit a U-Plane signal.

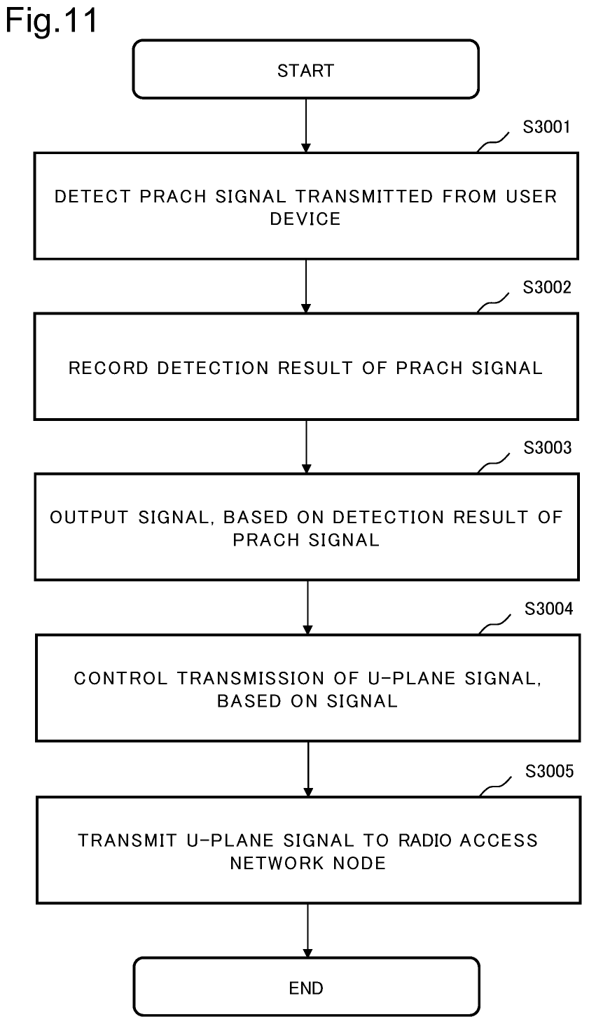

FIG. 11 is a flowchart illustrating an operation of the wireless device 3 according to the fourth example embodiment of the present disclosure.

In step S3001, the detection unit 12 of the wireless device 3 detects a PRACH signal transmitted from the user device 10. The detection unit 12 is equivalent to the detection 212 in FIG. 10. For example, referring to FIG. 10, a PRACH signal transmitted from the PRACH transmission unit 110 of the user device 10 is received by the wireless device 3. Then, the PRACH signal received by the wireless device 3 is analyzed in an order of the analog beam forming 201, the analog to digital 203, the filtering 204, the digital beam forming 206, and the redemapping 208, and detected in the detection 212.

In step S3002, the recording unit 13 of the wireless device 3 records a detection result of a PRACH signal by the detection unit 12. The recording unit 13 is equivalent to the recording unit 213 in FIG. 10. Note that, for example, referring to FIG. 10, the recording unit 213 is notified of a detection result of a PRACH signal by the detection 212. Then, the recording unit 213 records the detection result.

In step S3003, the recording unit 13 of the wireless device 3 outputs a signal to the transmission control unit 14, based on a detection result of a PRACH signal by the detection unit 12. For example, the signal includes a flag indicating whether the communication unit 11 transmits a U-Plane signal, based on a detection result of a PRACH signal by the detection unit 12. For example, referring to FIG. 10, the recording unit 213 outputs a signal including the flag to the transmission control unit 214.

In step S3004, the transmission control unit 14 of the wireless device 3 controls transmission of a U-Plane signal in the communication unit 11, based on a signal received from the recording unit 13. The transmission control unit 14 is equivalent to the transmission control unit 214 in FIG. 10. For example, referring to FIG. 10, the transmission control unit 214 controls transmission of a U-Plane signal by the IQ compression 211.

In step S3005, the communication unit 11 of the wireless device 3 performs transmission of a U-Plane signal, based on control of the transmission control unit 14. Specifically, the communication unit 11 transmits a U-Plane signal to the radio access network node 40 via the intermediate device 30. For example, the communication unit 11 is equivalent to the IQ compression 211 in FIG. 10. For example, referring to FIG. 10, the IQ compression 211 transmits a U-Plane signal to the intermediate device 30. The U-Plane signal received in the intermediate device 30 is transmitted to the O-RAN U-Plane synthesis unit 303 via the packet determination unit 302 of the intermediate device 30. Then, the O-RAN U-Plane synthesis unit 303 synthesizes the received U-Plane signal with a U-Plane signal transmitted from another wireless device 4 connected to the intermediate device 30.

The communication unit 11 transmits a detection result of a PRACH signal to the intermediate device 30. In this case, specifically, the packet determination unit 302 of the intermediate device 30 routes a U-Plane packet and a packet of a detection result. In this instance, as described in NPL 2, it may be assumed that, when eCPRI message=2, the packet determination unit 302 determines that a received packet is a C-Plane packet. It may be assumed that, when eCPRI message=0, the packet determination unit 302 determines that a received packet is a U-Plane packet. Note that, it may be assumed that, a packet of a detection result is defined as O-RAN C-Plane Section Type 8 in an O-RAN alliance. When determining that a received packet is a U-Plane packet, the packet determination unit 302 transfers the received packet to the O-RAN U-Plane synthesis unit 303. The O-RAN U-Plane synthesis unit 303 buffers a U-Plane packet of the same slot of the wireless device 3 and the wireless device 4. Then, the O-RAN U-Plane synthesis unit 303 adds and synthesizes IQ data within the U-Plane packets. When determining that a received packet is a detection result, the packet determination unit 302 transfers the detection result to the detection result reception unit 404 of the radio access network node 40.

Thereafter, the O-RAN U-Plane packet reception unit 405 of the radio access network node 40 receives the U-Plane signal synthesized in the intermediate device 30.

The wireless device 3 according to the fourth example embodiment performs control of transmission of a U-Plane signal, based on a signal output based on a detection result of a PRACH signal transmitted from the user device 10.

Therefore, the wireless device 3 according to the fourth example embodiment can perform control of transmission of a U-Plane signal, based on a detection result of a PRACH signal. Thus, similarly to the first to third example embodiments, a signal can be appropriately transmitted based on presence or absence of a user device. Further, in the present example embodiment, when transmission of a U-Plane signal is not performed from the wireless device 3 for a certain time, control can be performed in such a way that the wireless device 3 does not perform transmission of a U-Plane signal to the radio access network node 40. Thus, power saving of the wireless device can also be performed.

### Fifth Example Embodiment

Next, a fifth example embodiment of the present disclosure is described with reference to the drawings. It is assumed that a wireless device 1 according to the present example embodiment has a similar configuration to the wireless device 1 according to the first example embodiment. The present example embodiment is different from the first example embodiment in that an intermediate device controls transmission of a U-Plane signal.

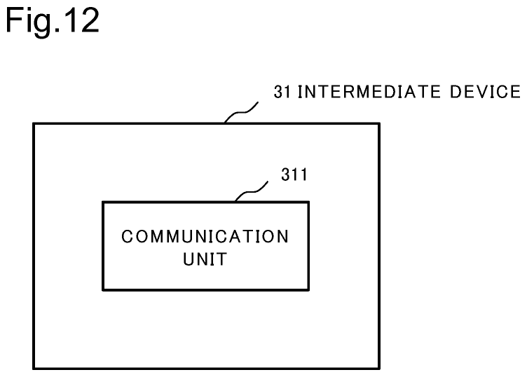

FIG. 12 is a block diagram illustrating a configuration of an intermediate device 31 according to the fifth example embodiment of the present disclosure.

Referring to FIG. 12, the intermediate device 31 according to the fifth example embodiment of the present disclosure includes a communication unit 311.

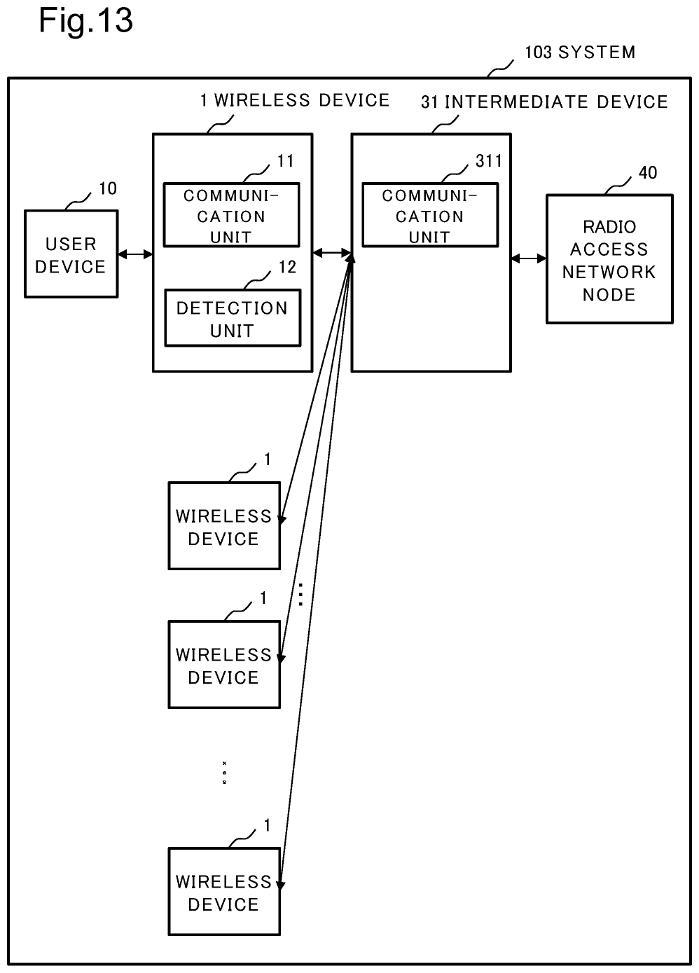

FIG. 13 is a block diagram illustrating a configuration of a wireless communication system 103 according to the fifth example embodiment of the present disclosure.

Referring to FIG. 13, the wireless communication system 103 according to the fifth example embodiment of the present disclosure includes a plurality of the wireless devices 1, a user device 10, the intermediate device 31, and a radio access network node 40.

The communication unit 11 of the wireless device 1 performs data reception from another device and transmission. The communication unit 11 receives a PRACH signal transmitted from the user device 10.

The detection unit 12 of the wireless device 1 detects that the user device 10 transmits a PRACH signal. The detection unit 12 notifies the communication unit 11 of the wireless device 1, of a detection result of a PRACH signal.

Further, the communication unit 11 of the wireless device 1 acquires the detection result of the PRACH signal from the detection unit 12. The communication unit 11 transmits the detection result of the PRACH signal to the communication unit 311 of the intermediate device 31.

The communication unit 311 of the intermediate device 31 communicates with the wireless device 1 and the radio access network node 40. The communication unit 311 receives, from the wireless device 1, a detection result of a PRACH signal transmitted from the user device 10. Herein, a detection result of a PRACH signal may be information indicating whether the detection unit 12 of the wireless device 1 detects, or may be the very PRACH signal.

Further, the communication unit 311 of the intermediate device 31 transmits, to the radio access network node 40, the U-Plane signal transmitted from the user device 10, based on the detection result of the PRACH signal. For example, it may be assumed that, when the detection unit 12 of the wireless device 1 detects a PRACH signal, the communication unit 311 transmits a U-Plane signal to the radio access network node 40. It may be assumed that, when the detection unit 12 of the wireless device 1 does not detect a PRACH signal, the communication unit 311 transmits no U-Plane signal to the radio access network node 40.

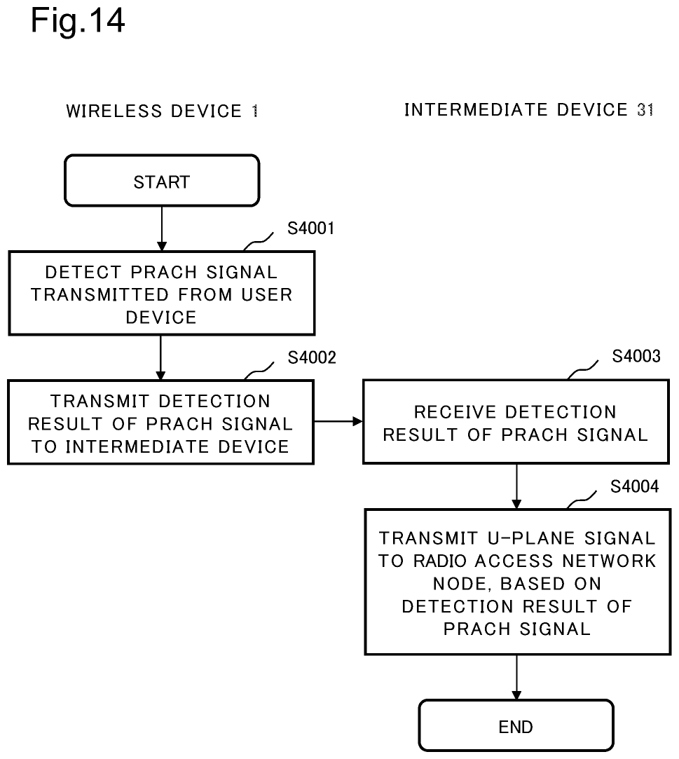

FIG. 14 is a flowchart illustrating an operation of the intermediate device 1 and the intermediate device 31 according to the fifth example embodiment of the present disclosure.

In step S4001, the detection unit 12 of the wireless device 1 detects a PRACH signal transmitted from the user device 10. The detection unit 12 notifies the communication unit 11 of a detection result of a PRACH signal. A detection result of a PRACH signal includes presence or absence of a PRACH signal, or a time of detection thereof, but is not limited thereto. For example, when detecting a PRACH signal, the detection unit 12 may output, to the communication unit 11, a signal indicating that a PRACH signal is detected. Alternatively, the detection unit 12 may output the very PRACH signal to the communication unit 11 as a detection result of a PRACH signal.

In step S4002, the communication unit 11 of the wireless device 1 transmits the detection result of the PRACH signal to the communication unit 311 of the intermediate device 31. Herein, the communication unit 11 of the wireless device 1 acquires the detection result of the PRACH signal from the detection unit 12.

In step S4003, the communication unit 311 of the intermediate device 31 receives, from the wireless device 1, a detection result of a PRACH signal transmitted from the user device 10.

In step S4004, the communication unit 311 of the intermediate device 31 performs transmission of a U-Plane signal, based on a detection result of a PRACH signal. Specifically, the communication unit 311 transmits a U-Plane signal to the radio access network node 40. Next, a more specific example of the present example embodiment is described.

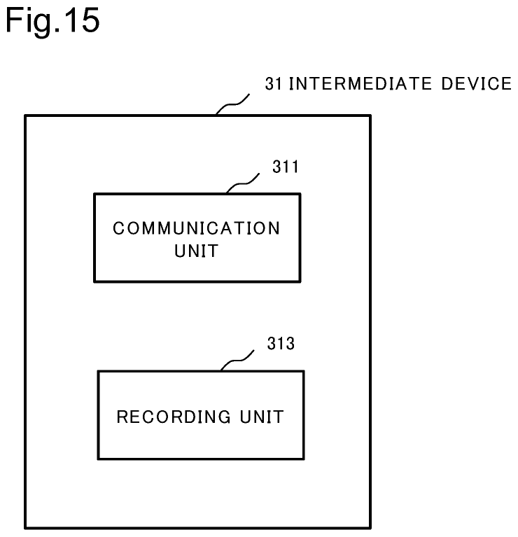

A first example according to the present example embodiment is described by use of FIG. 15. As illustrated in FIG. 15, the intermediate device 31 according to the present example may include a recording unit 313. An operation according to the present example is illustrated below.

The communication unit 311 of the intermediate device 31 further notifies the recording unit 313 of a detection result of a PRACH signal transmitted from the user device 10.

The recording unit 313 of an intermediate device 32 receives, from the communication unit 311, a notification regarding a detection result of a PRACH signal by the detection unit 12 of the wireless device 1. The recording unit 313 records the detection result of the PRACH signal. For example, the recording unit 313 may record the detection result of the PRACH signal in a memory, but is not limited thereto. For example, only when the detection unit 12 of the wireless device 1 detects a PRACH signal, the recording unit 313 may record the detection result. The recording unit 313 outputs a signal, based on a detection result of a PRACH signal. For example, the recording unit 313 may transmit, to the communication unit 311, a signal indicating that the detection unit 12 detects a PRACH signal. When the detection unit 12 of the wireless device 1 does not detect a PRACH signal, the recording unit 313 may output no signal. In addition, the recording unit 313 may output a signal, based on a past detection result of a PRACH signal by the detection unit 12 of the wireless device 1.

Further, the communication unit 311 of the intermediate device 31 transmits a U-Plane signal to the radio access network node 40, based on a signal output from the recording unit 313. For example, it may be assumed that, when acquiring, from the recording unit 313, a signal indicating that the detection unit 12 of the wireless device 1 detects a PRACH signal, the communication unit 311 transmits a U-Plane signal to the radio access network node 40. It may be assumed that, when not acquiring a signal from the recording unit 313, the communication unit 311 transmits no U-Plane signal to the radio access network node 40. It may be assumed that, when acquiring, from the recording unit 313, a signal indicating that the detection unit 12 of the wireless device 1 does not detect a PRACH signal, the communication unit 311 transmits no U-Plane signal to the radio access network node 40.

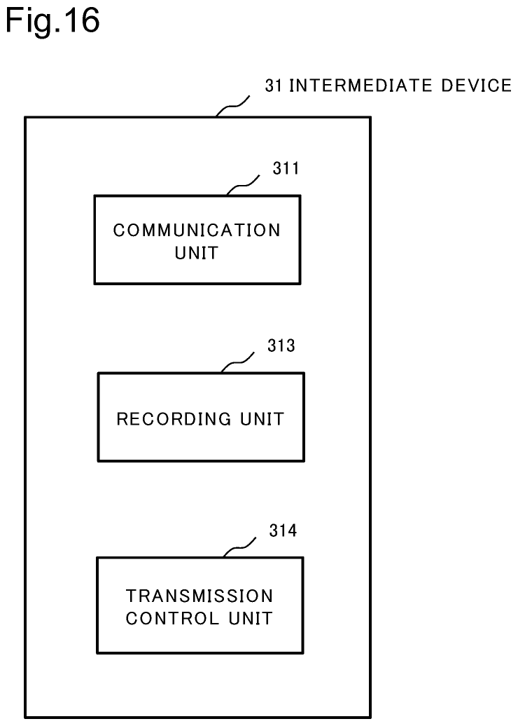

Next, a second example according to the present example embodiment is described by use of FIG. 16. As illustrated in FIG. 16, the intermediate device 31 according to the present example may include a transmission control unit 314. An operation according to the present example is illustrated below.

The recording unit 313 of the intermediate device 31 further outputs a signal to the transmission control unit 314, based on a detection result of a PRACH signal by the detection unit 12 of the wireless device 1. For example, the signal includes a flag as to whether the communication unit 311 transmits a U-Plane signal, based on a detection result of a PRACH signal by the detection unit 12. The signal may include a detection result of a PRACH signal by the detection unit 12. The recording unit 313 may output no signal when the detection unit 12 does not detect a PRACH signal.

The transmission control unit 314 of the intermediate device 31 controls transmission of a U-Plane signal in the communication unit 311, based on a signal received from the recording unit 313. For example, when a flag indicating that the communication unit 311 transmits a U-Plane signal is on in a received signal, the transmission control unit 314 permits the communication unit 311 to transmit a U-Plane signal. On the other hand, when the flag is off, the transmission control unit 314 does not permit the communication unit 311 to transmit a U-Plane signal.

Further, the communication unit 311 transmits a U-Plane signal to the radio access network node 40, based on control of the transmission control unit 314.

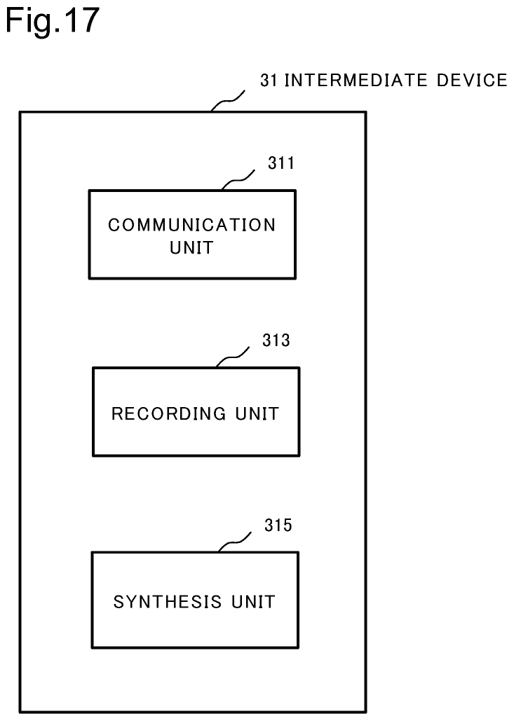

Next, a third example according to the present example embodiment is described by use of FIG. 17. As illustrated in FIG. 17, the intermediate device 31 according to the present example may include a synthesis unit 315. An operation according to the present example is illustrated below.

The synthesis unit 315 of the intermediate device 31 synthesizes a U-Plane signal received by the communication unit 311, based on a detection result of a PRACH signal by the detection unit 12 of the wireless device 1. It may be assumed that the synthesis unit 315 synthesizes a U-Plane signal, based on a detection result of the PRACH signal acquired from the recording unit 313. For example, it may be assumed that the synthesis unit 315 synthesizes a U-Plane signal received from a wireless device that transmits a PRACH signal detected by the detection unit 12. In this case, it may be assumed that a U-Plane signal transmitted from a wireless device that does not transmit a PRACH signal detected by the detection unit 12 is not synthesized. Note that, the synthesis unit 315 may acquire a detection result of the PRACH from the communication unit 311.

Further, the communication unit 311 transmits, to the radio access network node 40, a U-Plane signal synthesized by the synthesis unit 315. Note that, data transmitted from the user device 10 to the radio access network node 40 via a wireless device 20 are not limited to a U-Plane signal.

As described above, the intermediate device 31 according to the fifth example embodiment transmits a U-Plane signal, based on a detection result of a PRACH signal transmitted from the user device 10.

A function of a communication unit of an intermediate device, i.e., a function of transmitting a U-Plane signal, based on a detection result of a PRACH according to the present example embodiment is a function that is not defined in a current O-RAN alliance (a specification described in NPL 2). The present example embodiment also produces an advantageous effect that the wireless device can be configured by including the function not in a wireless device but in an intermediate device, without making a great change to a function (a specification described in NPL 2) defined by the current O-RAN alliance, in addition to a similar advantageous effect to that according to the first example embodiment.

### Sixth Example Embodiment

Next, a sixth example embodiment of the present disclosure is described with reference to the drawings. The present example embodiment is different from the first to fifth example embodiments in that an intermediate device includes a detection unit included in a wireless device in the first to fifth example embodiments.

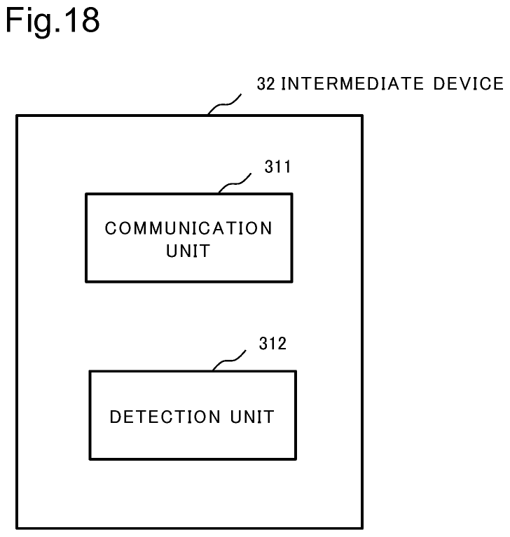

FIG. 18 is a block diagram illustrating a configuration of an intermediate device 32 according to a sixth example embodiment of the present disclosure.

Referring to FIG. 18, the intermediate device 32 according to the sixth example embodiment of the present disclosure includes a communication unit 311 and a detection unit 312.

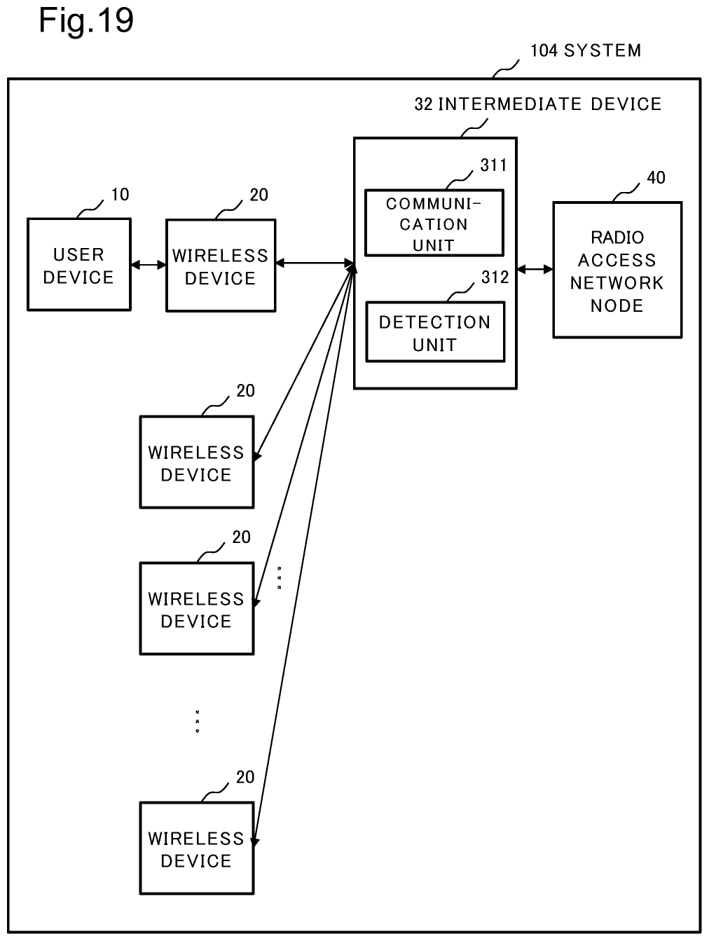

FIG. 19 is a block diagram illustrating a configuration of a wireless communication system 104 according to the sixth example embodiment of the present disclosure.

Referring to FIG. 19, the wireless communication system 104 according to the sixth example embodiment of the present disclosure includes a plurality of wireless devices 20, a user device 10, the intermediate device 32, and a radio access network node 40.

The wireless device 20 is a device that communicates with the user device 10, and performs processing of a wireless frequency. Although one user device is connected to one wireless device 20 in FIG. 19, a plurality of user devices may be connected to one wireless device 20. The wireless device 20 may be an O-RU described above, but is not limited thereto.

The user device 10 performs communication with the radio access network node 40 via the wireless device 20 and the intermediate device 32. The user device 10 may be UE described above, but is not limited thereto.

The intermediate device 32 is arranged between a plurality of the wireless devices 20 and the radio access network node 40. The intermediate device 32 duplicates or synthesizes and transmits signals from the wireless device 20 and the radio access network node 40. For example, the intermediate device 32 synthesizes uplink signals from a plurality of the wireless devices 20 (signals from the wireless device 20 to the radio access network node 40), and transmits the synthesized uplink signals to the radio access network node 40. Synthesis of uplink signals by the intermediate device 32 is not limited to simple synthesis (e.g., calculation of a sum or an average), and may be selective synthesis (e.g., simple synthesis of a plurality of selected uplink signals, simple synthesis after weighting a plurality of uplink signals, or the like). For example, the intermediate device 32 duplicates a downlink signal from the radio access network node 40 (a signal from the radio access network node 40 to the wireless device 20), and transmits the duplicated downlink signal to a plurality of the wireless devices 20. The intermediate device 32 may be an FHM described above, but is not limited thereto.

The communication unit 311 of the intermediate device 32 performs data reception from another device and transmission. The communication unit 311 receives data transmitted from a plurality of the wireless devices 20. Data received by the communication unit 311 from a plurality of the wireless devices 20 are, for example, a PRACH signal or a U-Plane signal. The communication unit 311 transmits, to the radio access network node 40, data transmitted from the user device 10 via the wireless device 20. For example, when an O-RAN U-Plane signal is transmitted from the user device 10 via the wireless device 20, based on an O-RAN C-Plane signal transmitted from the radio access network node 40, the U-Plane signal is transmitted to the radio access network node 40.

The detection unit 312 of the intermediate device 32 detects the PRACH signal transmitted from the user device 10 via the wireless device 20.

Further, the communication unit 311 transmits the U-Plane signal to the radio access network node 40, based on a detection result of a PRACH signal by the detection unit 312. Note that, data transmitted from the user device 10 to the radio access network node 40 via a wireless device 20 are not limited to a U-Plane signal.

The radio access network node 40 performs communication with the user device 10 via the wireless device 20 and the intermediate device 32. The radio access network node 40 may be an O-DU described above, but is not limited thereto.

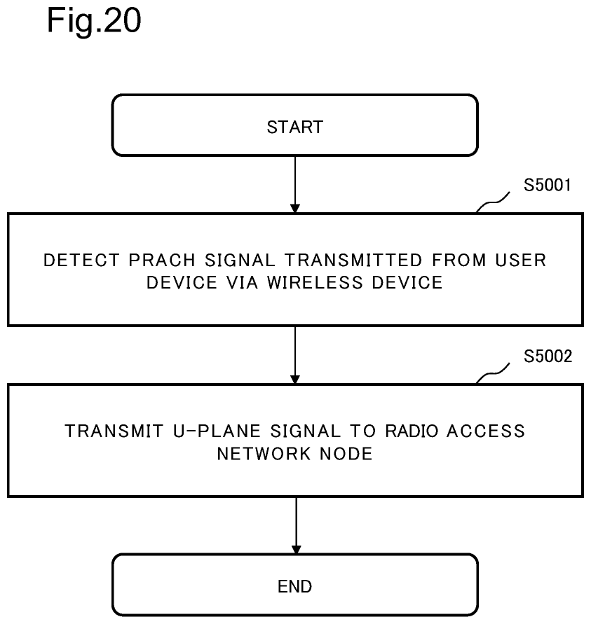

FIG. 20 is a flowchart illustrating an operation of the intermediate device 31 according to the sixth example embodiment of the present disclosure.

In step S5001, the detection unit 312 of the intermediate device 32 detects a PRACH signal transmitted from the user device 10 via the wireless device 20. The detection unit 312 may transmit a detection result of a PRACH signal to the communication unit 311. A detection result of a PRACH signal includes presence or absence of a PRACH signal, or a time of detection thereof, but is not limited thereto. For example, when detecting a PRACH signal, the detection unit 312 may output, to the communication unit 311, a signal including information that a PRACH signal is detected.

In step S5002, the communication unit 311 of the intermediate device 32 performs transmission of a U-Plane signal, based on a detection result of the PRACH signal. Specifically, the communication unit 311 receives a U-Plane signal transmitted from the wireless device 20, and transmits the received U-Plane signal to the radio access network node 40. A timing at which the communication unit 311 transmits a U-Plane signal follows, for example, transmission timing information of the U-Plane signal. The transmission timing information is included in, for example, a C-Plane signal transmitted from the radio access network node 40 via the intermediate device 32.

As described above, the intermediate device 32 according to the sixth example embodiment transmits a U-Plane signal to the radio access network node 40, based on a detection result of a PRACH signal transmitted from the user device 10.

Therefore, the intermediate device 32 according to the sixth example embodiment can transmit a U-Plane signal to the radio access network node 40, based on a detection result of a PRACH signal. Thus, the intermediate device 32 can appropriately transmit a signal, based on presence or absence of a user device. For example, it can be assumed that, when no user device connected to the wireless device 20 connected to the intermediate device 32 is present, the intermediate device 32 transmits no U-Plane signal received from the wireless device 20. Thereby, a problem that, in a cell in which no user device is present, interference from another cell, device noise, and the like are synthesized by an intermediate device, and demodulation performance in a radio access network node (e.g., an O-DU) deteriorates can be prevented.

### Seventh Example Embodiment

Now, a seventh example embodiment of the present disclosure is described with reference to the drawings. An intermediate device 33 according to the seventh example embodiment is different from the intermediate device 32 according to the sixth example embodiment in including a recording unit 313 in addition to the intermediate device 32 according to the sixth example embodiment.

Description is given in detail below with reference to the drawings. Note that, a similar component to that according to the sixth example embodiment is assigned with the same reference sign below, and description thereof is omitted.

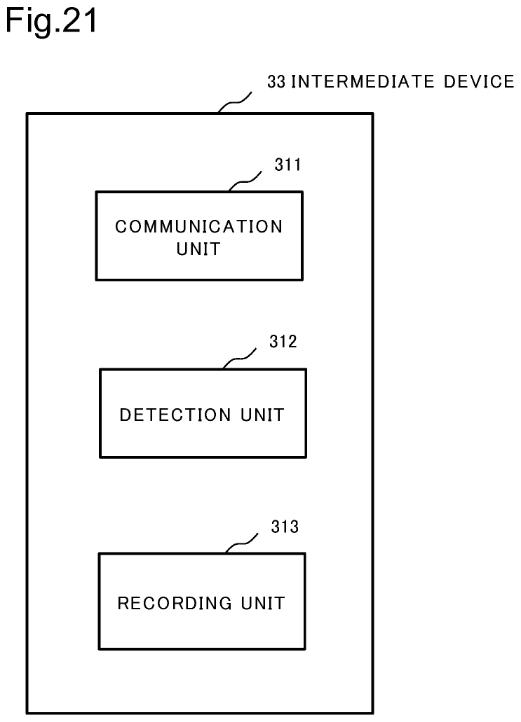

FIG. 21 is a block diagram illustrating a configuration of the intermediate device 33 according to the seventh example embodiment of the present disclosure.

Referring to FIG. 21, the intermediate device 33 according to the seventh example embodiment of the present disclosure includes a communication unit 311, a detection unit 312, and the recording unit 313.

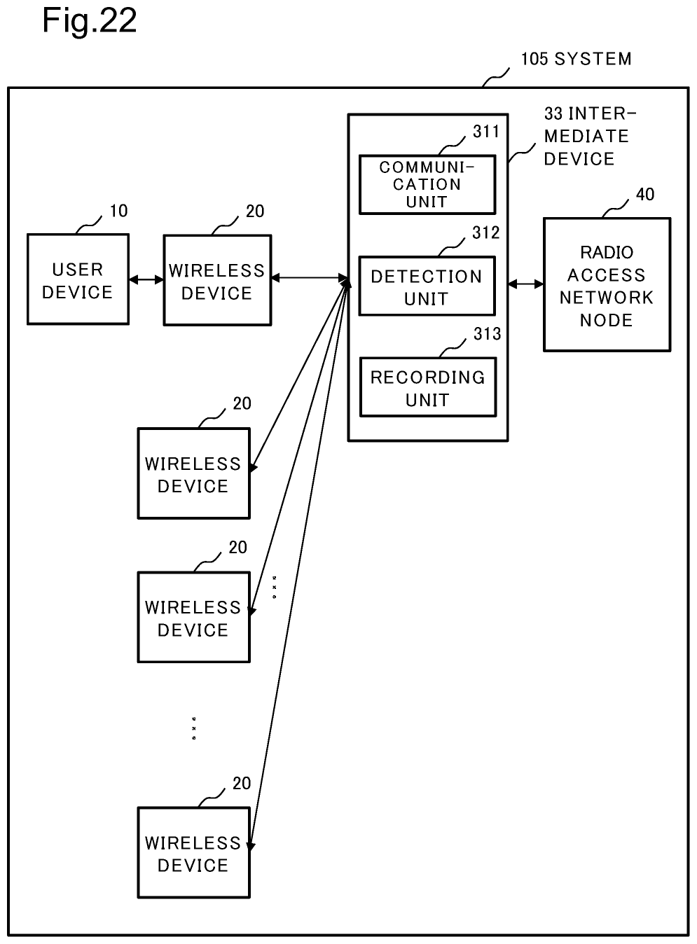

FIG. 22 is a block diagram illustrating a configuration of a wireless communication system 105 according to the seventh example embodiment of the present disclosure.

The wireless communication system 105 according to the seventh example embodiment of the present disclosure includes a plurality of wireless devices 20, a user device 10, the intermediate device 33, and a radio access network node 40.

The detection unit 312 of the intermediate device 33 detects that a PRACH signal is received from the user device 10 via the wireless device 20. The detection unit 312 notifies the recording unit 313 that a PRACH signal is detected.

The recording unit 313 of the intermediate device 33 receives a notification regarding a detection result of a PRACH signal by the detection unit 312. The recording unit 313 records the detection result of the PRACH signal by the detection unit 312. For example, the recording unit 313 may record the detection result of the PRACH signal by the detection unit 312 in a memory, but is not limited thereto. For example, only when the detection unit 312 detects a PRACH signal, the recording unit 313 may record the detection result. The recording unit 313 outputs a signal, based on a detection result of a PRACH signal by the detection unit 312. For example, the recording unit 313 may transmit, to the communication unit 311, a signal including information indicating that the detection unit 312 detects a PRACH signal. When the detection unit 312 does not detect a PRACH signal, the recording unit 313 may output no signal. In addition, the recording unit 313 may output a signal, based on a past detection result of a PRACH signal by the detection unit 12.

Further, the communication unit 311 transmits a U-Plane signal to the radio access network node 40, based on a signal output from the recording unit 313. For example, it may be assumed that, when acquiring, from the recording unit 313, a signal indicating that the detection unit 312 detects a PRACH signal, the communication unit 311 transmits a U-Plane signal to the radio access network node 40. It may be assumed that, when not acquiring a signal from the recording unit 313, the communication unit 311 transmits no U-Plane signal to the radio access network node 40. It may be assumed that, when acquiring, from the recording unit 313, a signal indicating that the detection unit 312 does not detect a PRACH signal, the communication unit 311 transmits no U-Plane signal to the radio access network node 40.

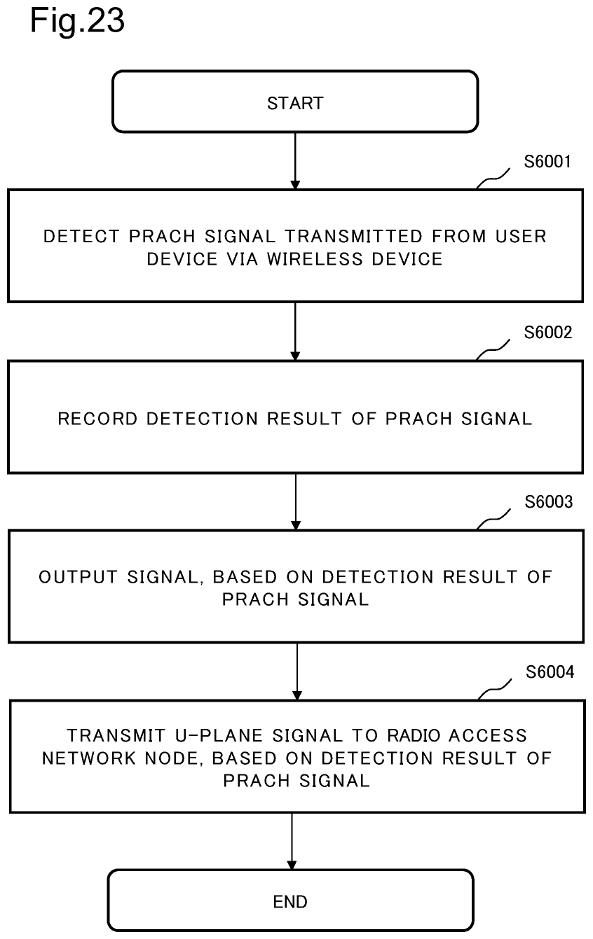

FIG. 23 is a flowchart illustrating an operation of the intermediate device 33 according to the seventh example embodiment of the present disclosure.

In step S6001, the detection unit 312 of the intermediate device 33 detects a PRACH signal transmitted from the user device 10 via the wireless device 20. The detection unit 312 notifies the recording unit 313 of a detection result of a PRACH signal. A detection result of a PRACH signal includes presence or absence of a PRACH signal, or a time of detection thereof, but is not limited thereto. For example, when detecting a PRACH signal, the detection unit 312 may output, to the recording unit 313, a signal indicating that a PRACH signal is detected. Note that, the detection unit 312 may notify of the communication unit 311, of a detection result of a PRACH signal.

In step S6002, the recording unit 313 of the intermediate device 33 records a detection result of a PRACH signal by the detection unit 312.

In step S6003, the recording unit 313 of the intermediate device 33 outputs a signal, based on a detection result of a PRACH signal by the detection unit 312. A signal output by the recording unit 313 may include a detection result of a PRACH signal by the detection unit 312. A signal output by the recording unit 313 may be a signal that controls transmission of a U-Plane signal by the communication unit 311. In this case, when a PRACH signal is detected by the detection unit 312, the recording unit 313 outputs a control signal that causes the communication unit 311 to transmit a U-Plane signal. When the detection unit 312 does not detect a PRACH signal, the recording unit 313 may output no control signal that causes the communication unit 311 to transmit a U-Plane signal. Alternatively, the recording unit 313 may output a control signal that controls in such a way that the communication unit 311 does not transmit a U-Plane signal.

In step S6004, the communication unit 311 of the intermediate device 33 performs transmission of a U-Plane signal, based on a detection result of a PRACH signal. Specifically, the communication unit 311 transmits a U-Plane signal to the radio access network node 40. The communication unit 311 acquires a detection result of the PRACH signal by receiving a signal output from the recording unit 313. The communication unit 311 may acquire permission/non-permission of transmission of a U-Plane signal, by receiving a signal output from the recording unit 313. Note that, it may be assumed that, the communication unit 311 acquires a detection result of the PRACH signal by receiving a signal output by the detection unit 312.

Note that, a timing at which the communication unit 311 transmits a U-Plane signal follows, for example, transmission timing information of the U-Plane signal. The transmission timing information is included in, for example, a C-Plane signal transmitted from the radio access network node 40 via the intermediate device 33. Thus, it may be assumed that the recording unit 313 records a detection result and transmission timing information after the detection unit 312 detects a PRACH signal. Then, it may be assumed that the recording unit 313 outputs, to the communication unit 311, a signal including a detection result of a PRACH signal when the transmission timing approaches. Alternatively, it may be assumed that the recording unit 313 outputs, to the communication unit 311, a signal that controls transmission of a U-Plane signal, when the transmission timing approaches.

The intermediate device 33 according to the seventh example embodiment records a detection result of a PRACH signal transmitted from the user device 10 via the wireless device 20, and performs transmission of a U-Plane signal to the radio access network node 40, based on a signal output based on the detection result.

Therefore, the intermediate device 33 according to the seventh example embodiment can record a detection result of a PRACH signal, and perform transmission of a U-Plane signal, based on a signal output based on the detection result.

Thereby, an advantageous effect similar to that according to the sixth example embodiment is provided in the present example embodiment as well.

### Eighth Example Embodiment

Now, an eighth example embodiment of the present disclosure is described with reference to the drawings. An intermediate device 34 according to the eighth example embodiment is different from the intermediate device 33 according to the seventh example embodiment in that the intermediate device 34 according to the eighth example embodiment further includes a transmission control unit 314.

Description is given in detail below with reference to the drawings. Note that, a similar component to that according to the seventh example embodiment is assigned with the same reference sign below, and description thereof is omitted.

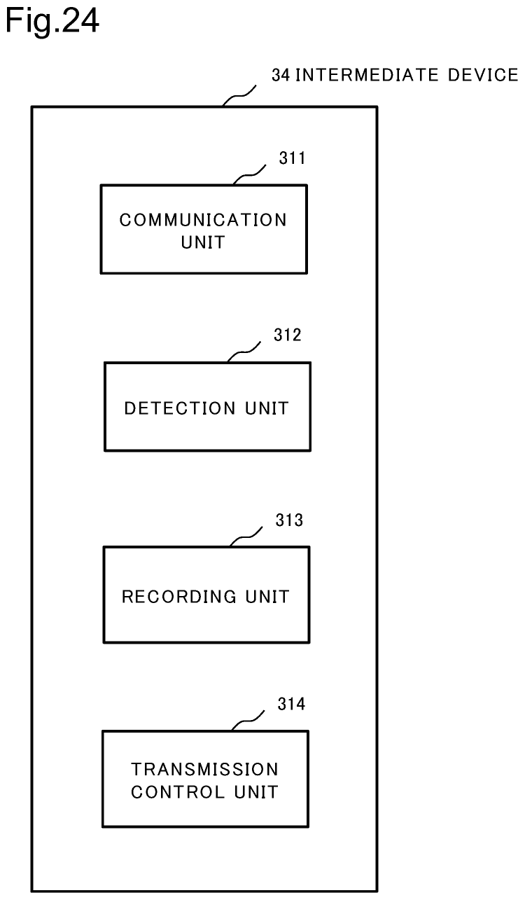

FIG. 24 is a block diagram illustrating a configuration of the intermediate device 34 according to an eighth example embodiment of the present disclosure.

Referring to FIG. 24, the intermediate device 34 according to the eighth example embodiment of the present disclosure includes a communication unit 311, a detection unit 312, a recording unit 313, and the transmission control unit 314.

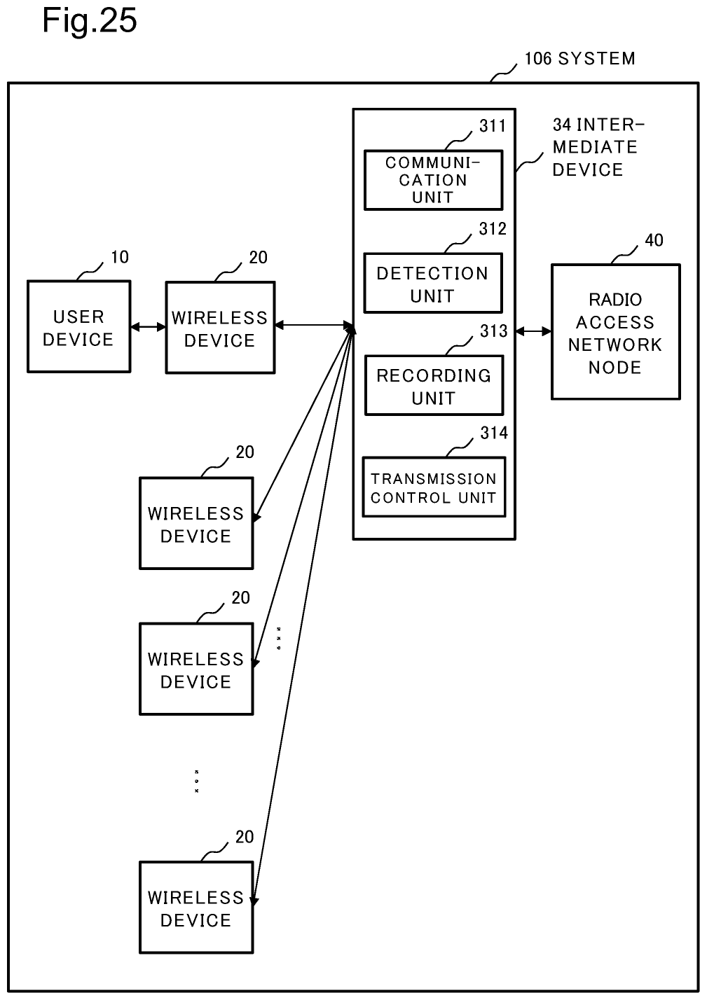

FIG. 25 is a block diagram illustrating a configuration of a wireless communication system 106 according to the eighth example embodiment of the present disclosure.

Referring to FIG. 25, the wireless communication system 106 according to the eighth example embodiment of the present disclosure includes a wireless device 20, a user device 10, the intermediate device 34, and a radio access network node 40.

The recording unit 313 of the intermediate device 34 receives a notification indicating a detection result of a PRACH signal by the detection unit 312. The recording unit 313 records the detection result of the PRACH signal by the detection unit 312. The recording unit 313 outputs a signal to the transmission control unit 314, based on a detection result of a PRACH signal by the detection unit 312. For example, the signal includes a flag as to whether the communication unit 311 performs transmission of a U-Plane signal, based on a detection result of a PRACH signal by the detection unit 312. The signal may include a detection result of a PRACH signal by the detection unit 312. The recording unit 313 may output no signal when the detection unit 312 does not detect a PRACH signal.

The transmission control unit 314 of the intermediate device 34 controls transmission of a U-Plane signal in the communication unit 311, based on a signal received from the recording unit 313. For example, when a flag indicating that the communication unit 311 transmits a U-Plane signal, based on a detection result of a PRACH signal by the detection unit 312 is on in a received signal, the communication unit 311 is permitted to transmit a U-Plane signal. In this case, when the flag is off, the communication unit 311 is not permitted to transmit a U-Plane signal

Further, the communication unit 311 transmits a U-Plane signal to the radio access network node 40, based on control of the transmission control unit 314.

It may be assumed that the transmission control unit 314 confirms whether a U-Plane signal is transmitted from the communication unit 311 to the radio access network node 40. Then, unless transmission of a U-Plane signal is performed for a certain time, the transmission control unit 314 may inhibit the communication unit 311 from transmitting a U-Plane signal. In this case, it may be assumed that, until a signal is received from the recording unit 313 again, the transmission control unit 314 inhibits the communication unit 311 from transmitting a U-Plane signal. In other words, it may be assumed that, only when a signal is received from the recording unit 313 again, the transmission control unit 314 permits the communication unit 311 to transmit a U-Plane signal.

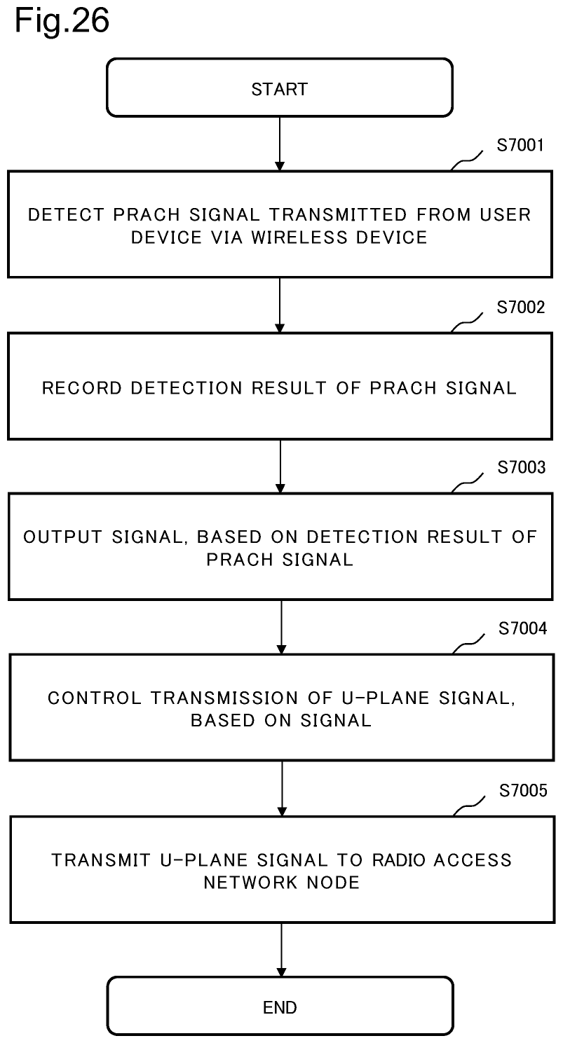

FIG. 26 is a flowchart illustrating an operation of an intermediate device 34 according to the eighth example embodiment of the present disclosure.

In step S7001, the detection unit 312 of the intermediate device 34 detects a PRACH signal transmitted from the user device 10 via the wireless device 20.

In step S7002, the recording unit 313 of the intermediate device 34 records a detection result of a PRACH signal by the detection unit 312.

In step S7003, the recording unit 313 of the intermediate device 34 outputs a signal to the transmission control unit 314, based on a detection result of a PRACH signal by the detection unit 312. For example, the signal includes a flag indicating whether the communication unit 311 transmits a U-Plane signal, based on a detection result of a PRACH signal by the detection unit 312.

In step S7004, the transmission control unit 314 of the intermediate device 34 controls transmission of a U-Plane signal in the communication unit 311, based on a signal received from the recording unit 313.

In step S7005, the communication unit 311 of the intermediate device 34 performs transmission of a U-Plane signal, based on control of the transmission control unit 314. Specifically, the communication unit 311 transmits a U-Plane signal to the radio access network node 40.

The intermediate device 34 according to the eighth example embodiment performs control of transmission of a U-Plane signal, based on a signal output based on a detection result of a PRACH signal transmitted from the user device 10 via the wireless device 20.

Therefore, the intermediate device 34 according to the eighth example embodiment can perform control of transmission of a U-Plane signal, based on a detection result of a PRACH signal. Thus, a signal can be appropriately transmitted, based on presence or absence of a user device. Further, unless transmission of a U-Plane signal is performed for a certain time, transmission of a U-Plane signal can be controlled. Thus, power saving of an intermediate device can be performed.

### Ninth Example Embodiment

Next, a ninth example embodiment of the present disclosure is described with reference to the drawings. The present example embodiment is different from the fifth example embodiment in that an intermediate device 35 includes a synthesis unit.

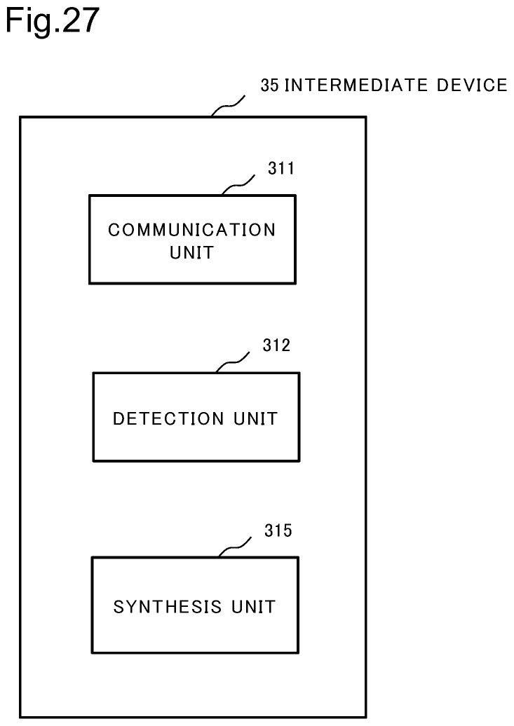

FIG. 27 is a block diagram illustrating a configuration of an intermediate device 35 according to the ninth example embodiment of the present disclosure.

Referring to FIG. 27, the intermediate device 35 according to the ninth example embodiment of the present disclosure includes a communication unit 311, a detection unit 312, and a synthesis unit 315.

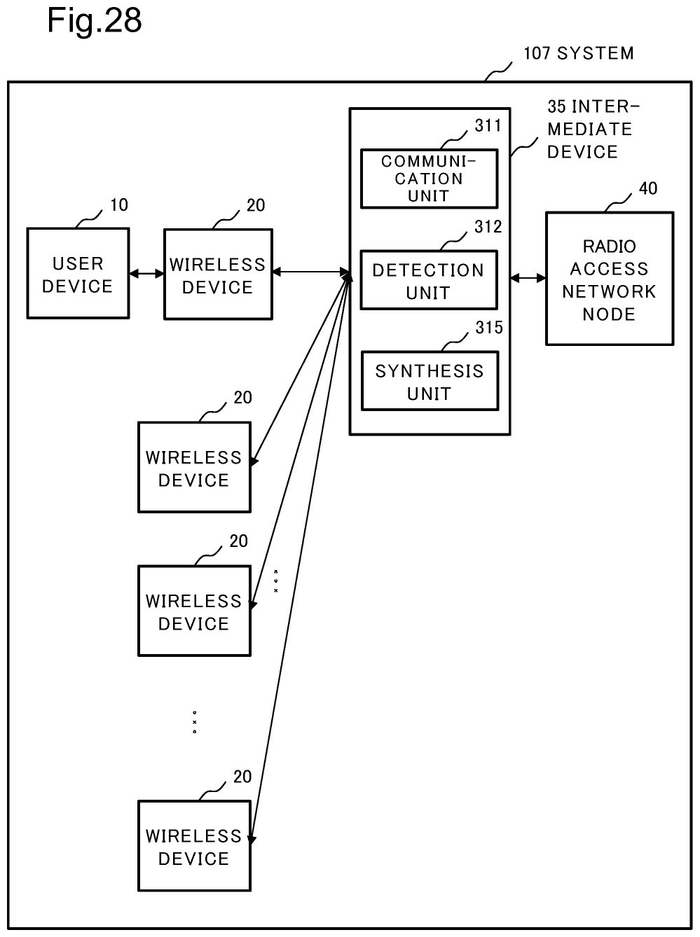

FIG. 28 illustrates a configuration of a wireless communication system 107 according to the ninth example embodiment of the present disclosure. Referring to FIG. 28, the configuration of the wireless communication system 107 according to the ninth example embodiment of the present disclosure is a configuration in which the synthesis unit 315 is added to an intermediate device 32 in FIG. 18.

The wireless device 20 is a device that communicates with the user device 10, and performs processing of a wireless frequency. Although one user device is connected to one wireless device 20 in FIG. 28, a plurality of user devices may be connected to one wireless device 20. The wireless device 20 may be an O-RU described above, but is not limited thereto.

The user device 10 performs communication with the radio access network node 40 via the wireless device 20 and the intermediate device 35. The user device 10 may be UE described above, but is not limited thereto.

The intermediate device 35 is arranged between a plurality of the wireless devices 20 and the radio access network node 40. The intermediate device 35 duplicates or synthesizes and transmits signals from the wireless device 20 and the radio access network node 40. For example, the intermediate device 35 synthesizes uplink signals from a plurality of the wireless devices 20 (signals from the wireless device 20 to the radio access network node 40), and transmits the synthesized uplink signals to the radio access network node 40. Synthesis of uplink signals by the intermediate device 35 is not limited to simple synthesis (e.g., calculation of a sum or an average), and may be selective synthesis (e.g., simple synthesis of a plurality of selected uplink signals, simple synthesis after weighting a plurality of uplink signals, or the like). For example, the intermediate device 35 duplicates a downlink signal from the radio access network node 40 (a signal from the radio access network node 40 to the wireless device 20), and transmits the duplicated uplink signal to a plurality of the wireless devices 20. The intermediate device 35 may be an FHM described above, but is not limited thereto.

A communication unit 311 of the intermediate device 35 performs data reception from another device and transmission. The communication unit 311 receives data transmitted from a plurality of the wireless devices 20. Data received by the communication unit 311 from a plurality of the wireless devices 20 are, for example, a PRACH signal or a U-Plane signal. The communication unit 311 transmits, to the radio access network node 40, data transmitted from the user device 10 via the wireless device 20. For example, when a U-Plane signal is transmitted from the user device 10 via the wireless device 20, based on a C-Plane signal transmitted from the radio access network node 40, the U-Plane signal is transmitted to the radio access network node 40.

The detection unit 312 of the intermediate device 35 detects the PRACH signal transmitted from the user device 10 via the wireless device 20.

The synthesis unit 315 of the intermediate device 35 synthesizes a U-Plane signal received by the communication unit 311, based on a detection result of a PRACH signal by the detection unit 312. For example, it may be assumed that the synthesis unit 315 synthesizes a U-Plane signal received from a wireless device that transmits a PRACH signal detected by the detection unit 312. In this case, it may be assumed that a U-Plane signal received from a wireless device that does not transmit a PRACH signal detected by the detection unit 312 is not synthesized.

Further, the communication unit 311 transmits, to the radio access network node 40, a U-Plane signal synthesized by the synthesis unit 315. Note that, data transmitted from the user device 10 to the radio access network node 40 via a wireless device 20 are not limited to a U-Plane signal.

The radio access network node 40 performs communication with the user device 10 via the wireless device 20 and the intermediate device 35. The radio access network node 40 may be an O-DU described above, but is not limited thereto.

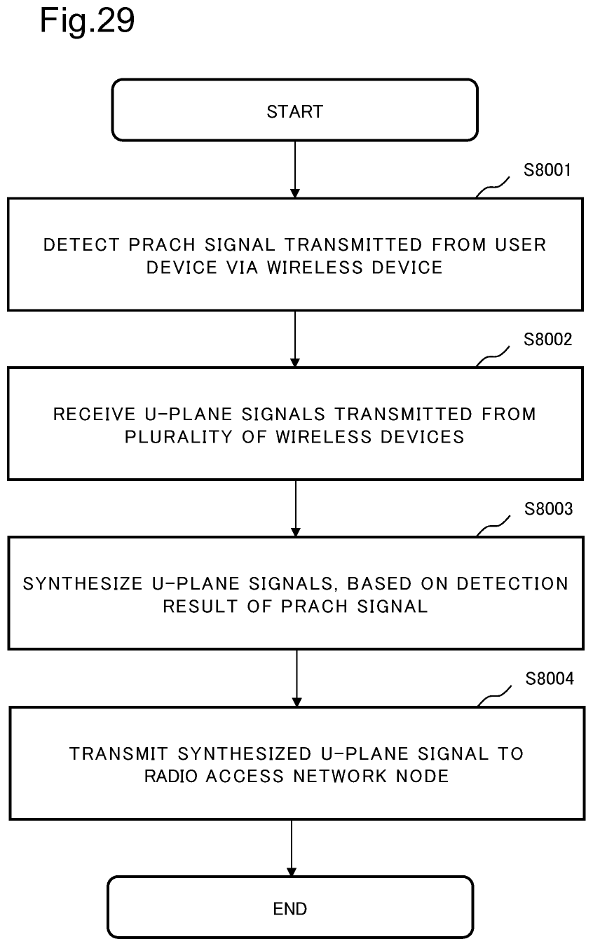

FIG. 29 is a flowchart illustrating an operation of the intermediate device 35 according to the ninth example embodiment of the present disclosure.

In step S8001, the detection unit 312 of the intermediate device 35 detects a PRACH signal transmitted from the user device 10 via the wireless device 20. The detection unit 312 may transmit a detection result of a PRACH signal to the synthesis unit 315. A detection result of a PRACH signal includes presence or absence of a PRACH signal, or a time of detection thereof, but is not limited thereto. For example, when detecting a PRACH signal, the detection unit 312 may output, to the synthesis unit 315, a signal including information that a PRACH signal is detected. Alternatively, a detection result of a PRACH signal transmitted by the detection unit 312 may be the very PRACH signal detected by the detection unit 312.

In step S8002, the communication unit 311 of the intermediate device 35 receives U-Plane signals transmitted from a plurality of the wireless devices 20.

In step S8003, the synthesis unit 315 of the intermediate device 35 performs, based on a detection result of a PRACH signal by the detection unit 312, synthesis of the U-Plane signals received by the communication unit 311. Specifically, the synthesis unit 315 synthesizes a U-Plane signal received from the wireless device 20 that transmits the PRACH signal detected by the detection unit 312. In this instance, the synthesis unit 315 does not synthesize a U-Plane signal received from the wireless device 20 that does not transmit the PRACH signal detected by the detection unit 312. The synthesis unit 315 may acquire a detection result of a PRACH signal from the detection unit 312 by a signal or the like, but an acquisition method is not limited thereto. A signal from the detection unit 312 may be a signal indicating a detection result, or may be a signal that controls synthesis of a U-Plane signal by the synthesis unit 315.

In step S8004, the communication unit 311 transmits, to the radio access network node 40, the U-Plane signal synthesized by the synthesis unit 315. A timing at which the communication unit 311 transmits a U-Plane signal follows, for example, transmission timing information of the U-Plane signal. The transmission timing information is included in, for example, a C-Plane signal transmitted from the radio access network node via the intermediate device 35.

As described above, the intermediate device 35 according to the ninth example embodiment synthesizes a U-Plane signal, based on a detection result of a PRACH signal transmitted from the user device 10.

Therefore, the intermediate device 35 according to the ninth example embodiment can transmit, to the radio access network node 40, a U-Plane signal synthesized based on a detection result of a PRACH signal. Thus, the intermediate device 35 can appropriately transmit a signal, based on presence or absence of a user device. For example, it can be assumed that, when no user device connected to the wireless device 20 is present, the intermediate device 35 does not synthesize the U-Plane signal received from the wireless device 20. Thereby, a problem that, in a cell in which no user device is present, interference from another cell, device noise, and the like are synthesized by an intermediate device, and demodulation performance in a radio access network node (e.g. an O-DU) deteriorates can be prevented.

Note that, the intermediate device 35 according to the present example embodiment may have a configuration including a recording unit 313 according to the seventh example embodiment.

While the present disclosure has been described above with reference to each exemplary embodiment and specific example, the present disclosure is not limited to the exemplary embodiments described above. Various changes understandable by those of ordinary skill in the art can be made to a configuration and details of the present disclosure within the scope of the present disclosure.

For example, the steps in processing described in the present specification may not necessarily be executed in time series in an order described in a flowchart. For example, steps in processing may be executed in an order being different from an order described as a figure, or may be executed in parallel. Some of steps in processing may be deleted, and a further step may be added to processing.

A method including processing of a component (e.g., at least one of a communication unit, a detection unit, a recording unit, and a transmission control unit) of an information device described in the present disclosure may be provided, and a program for causing a processor to execute processing of the component described above may be provided. A non-transitory computer readable recording medium recording the program may be provided. Naturally, such a device, a module, a method, a program, and a non-transitory computer readable recording medium are also included in the present disclosure.

Some or all of the above-described example embodiments can also be described as, but are not limited to, the following supplementary notes.

### (Supplementary Note 1)

A wireless device that communicates with a user device, and performs processing of a wireless frequency, the wireless device including:
a communication unit that communicates with an intermediate device duplicating or synthesizing and transmitting a signal between a radio access network node communicating with the user device via the wireless device, and a plurality of the wireless devices; and
a detection unit that detects a PRACH signal transmitted from the user device, wherein
the communication unit performs transmission of a U-Plane signal to the radio access network node via the intermediate device, based on a detection result of the PRACH signal by the detection unit.

### (Supplementary Note 2)

The wireless device according to supplementary note 1, further including a recording unit that records the detection result.

### (Supplementary Note 3)

The wireless device according to supplementary note 2, further including a transmission control unit that controls transmission of the U-Plane signal by the communication unit, based on the detection result.

### (Supplementary Note 4)

The wireless device according to supplementary note 3, wherein
the recording unit further outputs a signal, based on the detection result, and
the transmission control unit controls, based on the signal, transmission of the U-Plane signal by the communication unit.

### (Supplementary Note 5)

The wireless device according to supplementary note 4, wherein the transmission control unit further confirms presence or absence of transmission of the U-Plane signal by the communication unit.

### (Supplementary Note 6)

The wireless device according to supplementary note 5, wherein, when no transmission of the U-Plane signal by the communication unit is present for a certain time, the transmission control unit controls in such a way that the communication unit does not transmit the U-Plane signal.

### (Supplementary Note 7)

The wireless device according to supplementary note 1 or 2, wherein the wireless device is an O-RAN radio unit (O-RU).

### (Supplementary Note 8)

The wireless device according to supplementary note 1, wherein the communication unit further transmits, to the radio access network node, information of the PRACH signal detected by the detection unit.

### (Supplementary Note 9)

The wireless device according to supplementary note 2, wherein the recording unit acquires the detection result from the detection unit.

### (Supplementary Note 10)

The wireless device according to supplementary note 4, wherein, when the detection unit detects the PRACH signal, the recording unit outputs a control signal that permits the communication unit to transmit the U-Plane signal.

### (Supplementary Note 11)

The wireless device according to supplementary note 1, wherein the radio access network node is an O-RAN distributed unit (O-DU).

### (Supplementary Note 12)

An intermediate device that duplicates or synthesizes and transmits a signal between a plurality of wireless devices communicating with a user device, and a radio access network node communicating with the user device via the wireless device, the intermediate device including
a communication unit that communicates with the wireless device and the radio access network node, wherein
the communication unit receives, from the wireless device, a detection result of a PRACH signal transmitted from the user device, and
the communication unit transmits, to the radio access network node, a U-Plane signal received from the wireless device, based on the detection result.

### (Supplementary Note 13)

The intermediate device according to supplementary note 12, wherein the intermediate device is a fronthaul multiplexer (FHM).

### (Supplementary Note 14)

The intermediate device according to supplementary note 12, further including:
a recording unit that records the detection result; and
a transmission control unit that controls, based on the detection result, transmission of the U-Plane signal by the communication unit.

### (Supplementary Note 15)

The intermediate device according to supplementary note 12, further including a synthesis unit that synthesizes, based on the detection result, a U-Plane signal received from the wireless device.

### (Supplementary Note 16)

A method to be executed in a wireless device that communicates with a user device, and performs processing of a wireless frequency, the method including:
communicating with an intermediate device that duplicates or synthesizes and transmits a signal between a radio access network node communicating with the user device via the wireless device, and a plurality of the wireless devices;
detecting a PRACH signal transmitted from the user device; and
performing transmission of a U-Plane signal to the radio access network node via the intermediate device, based on a detection result of the PRACH signal.

### (Supplementary Note 17)

A program for causing, to execute a method, one or more processors of a wireless device that communicates with a user device, and performs processing of a wireless frequency, the method including:
communicating with an intermediate device that duplicates or synthesizes and transmits a signal between a radio access network node communicating with the user device via the wireless device, and a plurality of the wireless devices;
detecting a PRACH signal transmitted from the user device; and
performing transmission of a U-Plane signal to the radio access network node via the intermediate device, based on a detection result of the PRACH signal.

### (Supplementary Note 18)

A wireless communication system including a plurality of wireless devices, a radio access network node that performs communication with a user device via a plurality of the wireless devices, and an intermediate device that duplicates or synthesizes and transmits a signal between a plurality of the wireless devices and the radio access network node, the wireless communication system including:
a detection unit that detects a PRACH signal transmitted from the user device; and
a communication unit that performs transmission of a U-Plane signal to the radio access network node, based on a detection result of the PRACH signal by the detection unit.

### (Supplementary Note 19)

A method to be executed in an intermediate device that duplicates or synthesizes and transmits a signal between a wireless device communicating with a user device, and a radio access network node communicating with the user device via the wireless device, the method including:
communicating with the wireless device and the radio access network node;
receiving, from the wireless device, a detection result of a PRACH signal transmitted from the user device; and
transmitting, to the radio access network node, a U-Plane signal received from the wireless device, based on the detection result.

### (Supplementary Note 20)

A program for causing, to execute a method, one or more processors of an intermediate device that duplicates or synthesizes and transmits a signal between a wireless device communicating with a user device, and a radio access network node communicating with the user device via the wireless device, the method including:
communicating with the wireless device and the radio access network node;
receiving, from the wireless device, a detection result of a PRACH signal transmitted from the user device; and
transmitting, to the radio access network node, a U-Plane signal received from the wireless device, based on the detection result.

### (Supplementary Note 21)

A method to be executed in a wireless communication system including a plurality of wireless devices, a radio access network node that performs communication with a user device via a plurality of the wireless devices, and an intermediate device that duplicates or synthesizes and transmits a signal between a plurality of the wireless devices and the radio access network node, the method including:
detecting a PRACH signal transmitted from the user device; and
performing transmission of a U-Plane signal to the radio access network node, based on a detection result of the detected PRACH signal.

### (Supplementary Note 22)

A program for causing, to execute a method, one or more processors of a wireless communication system including a plurality of wireless devices, a radio access network node that performs communication with a user device via a plurality of the wireless devices, and an intermediate device that duplicates or synthesizes and transmits a signal between a plurality of the wireless devices and the radio access network node, the method including:
detecting a PRACH signal transmitted from the user device; and
performing transmission of a U-Plane signal to the radio access network node, based on a detection result of the detected PRACH signal.

1. A wireless device that communicates with a user device, and performs processing of a wireless frequency, the wireless device comprising:
a communication unit that communicates with an intermediate device duplicating or synthesizing and transmitting a signal between a radio access network node communicating with the user device via the wireless device, and a plurality of the wireless devices; and
a detection unit that detects a PRACH signal transmitted from the user device, wherein
the communication unit performs transmission of a U-Plane signal to the radio access network node via the intermediate device, based on a detection result of the PRACH signal by the detection unit.

2. The wireless device according to claim 1, further comprising a recording unit that records the detection result.

3. The wireless device according to claim 2, further comprising a transmission control unit that controls transmission of the U-Plane signal by the communication unit, based on the detection result.

4. The wireless device according to claim 3, wherein
the recording unit further outputs a signal, based on the detection result, and
the transmission control unit controls, based on the signal, transmission of the U-Plane signal by the communication unit.

5. The wireless device according to claim 4, wherein the transmission control unit further confirms presence or absence of transmission of the U-Plane signal by the communication unit.

6. The wireless device according to claim 4, wherein, when no transmission of the U-Plane signal by the communication unit is present for a certain time, the transmission control unit controls in such a way that the communication unit does not transmit the U-Plane signal.

7. The wireless device according to claim 1, wherein the wireless device is an O-RAN radio unit (O-RU).

8. The wireless device according to claim 2, wherein the wireless device is an O-RAN radio unit (O-RU).

9. The wireless device according to claim 1, wherein the communication unit further transmits, to the radio access network node, information of the PRACH signal detected by the detection unit.

10. The wireless device according to claim 2, wherein the recording unit acquires the detection result from the detection unit.

11. The wireless device according to claim 4, wherein, when the detection unit detects the PRACH signal, the recording unit outputs a control signal that permits the communication unit to transmit the U-Plane signal.

12. The wireless device according to claim 1, wherein the radio access network node is an O-RAN distributed unit (O-DU).

13. An intermediate device that duplicates or synthesizes and transmits a signal between a plurality of wireless devices communicating with a user device, and a radio access network node communicating with the user device via the wireless device, the intermediate device comprising
a communication unit that communicates with the wireless device and the radio access network node, wherein
the communication unit receives, from the wireless device, a detection result of a PRACH signal transmitted from the user device, and
the communication unit transmits, to the radio access network node, a U-Plane signal received from the wireless device, based on the detection result.

14. The intermediate device according to claim 13, wherein the intermediate device is a fronthaul multiplexer (FHM).

15. The intermediate device according to claim 13, further comprising:
a recording unit that records the detection result.

16. The intermediate device according to claim 15, further comprising:
a transmission control unit that controls transmission of the U-Plane signal by the communication unit, based on the detection result.

17. The intermediate device according to claim 13, further comprising
a synthesis unit that synthesizes, based on the detection result, a U-Plane signal received from the wireless device.

18. A method to be executed in a wireless device that communicates with a user device, and performs processing of a wireless frequency, the method comprising:
communicating with an intermediate device that duplicates or synthesizes and transmits a signal between a radio access network node communicating with the user device via the wireless device, and a plurality of the wireless devices;
detecting a PRACH signal transmitted from the user device; and
performing transmission of a U-Plane signal to the radio access network node via the intermediate device, based on a detection result of the PRACH signal.

19. The method according to claim 18, further comprising:
recording a detection result.

20. The method according to claim 19, further comprising:
controlling transmission of the U-Plane signal based on the detection result.
